(19) United States
(12) Patent Application Publication
(10) Pub. No.: US 2025/0343486 A1
(43) Pub. Date: Nov. 6, 2025

(54) HALF-BRIDGE CONTROL CIRCUIT, AHB, AND METHOD

(71) Applicant: ZHUHAI NANXIN SEMICONDUCTOR TECHNOLOGY CO.,LTD., Zhuhai (CN)

(72) Inventors: Changle XU, Shanghai (CN); Nan WANG, Shanghai (CN); Jianlong GAO, Shanghai (CN); Lin FENG, Shanghai (CN)

(73) Assignee: ZHUHAI NANXIN SEMICONDUCTOR TECHNOLOGY CO.,LTD., Zhuhai (CN)

(21) Appl. No.: 19/194,146

(22) Filed: Apr. 30, 2025

(30) Foreign Application Priority Data
May 6, 2024 (CN) 202410546541.8

(51) Int. Cl. H02M 3/28

(52) U.S. Cl. CPC H02M 3/28

(57) ABSTRACT

A half-bridge control circuit, an Asymmetric Half Bridge Converter (AHB), a device, and a method are provided. The half-bridge control circuit includes a primary controller unit, an isolated communication unit, and a secondary controller unit, wherein the primary controller unit is configured to drive a first switching tube and a second switching tube to conduct in different time periods, and the secondary controller unit is configured to drive a synchronous rectifier tube to conduct or turn off; in one switching cycle, the secondary controller unit is configured to determine a turn-off time of the second switching tube, and send a first turn-off signal to the primary controller unit through the isolated communication unit at the turn-off time; and the primary controller unit is configured to control the second switching tube to turn off in response to the first turn-off signal.

### CROSS-REFERENCE TO THE RELATED APPLICATIONS

This application is based upon and claims priority to Chinese Patent Application No. 202410546541.8, filed on May 6, 2024, the entire contents of which are incorporated herein by reference.

### TECHNICAL FIELD

The present disclosure relates to the technical field of electronic power, and in particular, to a half-bridge control circuit, an Asymmetric Half Bridge converter (AHB), a device, and a method.

### BACKGROUND

An AHB has two switching tubes at a primary side of a transformer, which may be provided in a half-bridge configuration and driven by different Pulse Width Modulation (PWM) signals for the two switching tubes.

A circuit diagram of a conventional AHB is shown in FIG. 1. A first switching tube Q₁ and a second switching tube Q₂ form a half-bridge circuit of the AHB. The AHB may further include a primary controller, an isolation optical coupler, a secondary protocol controller, a secondary synchronous rectifier controller, and other devices. The primary controller is configured to drive the first switching tube Q₁ and the second switching tube Q₂ to turn on in different time periods. The secondary protocol controller transmits a feedback signal (e.g., output power information of the transformer T) to the primary controller in a unidirectional manner through the isolation optical coupler, so that the primary controller controls turn-on times of the first switching tube Q₁ and the second switching tube Q₂ according to the output power information. The secondary synchronous rectifier controller controls a synchronous rectifier tube Q₃ to turn on and turn off by detecting information of the synchronous rectifier tube Q₃ connected in series with a secondary winding of the transformer T. In the same switching cycle, the first switching tube Q₁ and the second switching tube Q₂ are conducted in different time periods to transfer an input voltage Vᵢₙ from a primary side of the transformer to a secondary side.

At present, the second switching tube Q₂ in the AHB may be turned off through the following solution.

In a case that the AHB operates in a Critical Mode (CrM), as shown in FIG. 2 and FIG. 3, the primary controller may extend a period of time based on a zero-crossing time of an excitation current as a turn-off time of the second switching tube Q₂, or extend a period of time based on a fixed turn-off time set inside the primary controller as the turn-off time of the second switching tube Q₂, so as to achieve Zero Voltage Switching (ZVS) of the first switching tube Q₁. As shown in FIG. 4, in a case that the AHB operates in a Discontinuous Conduction Mode (DCM), the primary controller may use the zero-crossing time of the excitation current of the transformer T as the turn-off time of the second switching tube Q₂, or set the fixed turn-off time inside the primary controller, and the primary controller dynamically compensates for the above fixed turn-off time according to different output voltages detected by an auxiliary winding of the transformer T.

However, at present, the primary controller detects excitation and demagnetization processes of the transformer T through Zero Current Detection (ZCD) of the auxiliary winding. Based on the volt-second balance of the transformer T, the primary controller obtains the zero-crossing time of the excitation current of the transformer by internal calculation, however, due to a sampling error, it is difficult to accurately calculate the turn-off time. Under dynamic conditions, the volt-second balance of the transformer T is not established. A volt-second balance circuit inside the primary controller is complex, which increases the complexity of the control circuit. In addition, the fixed turn-off time is set inside the primary controller, which is difficult to accurately match for applications in different power ranges, and the dynamic compensation under a wide range of output voltages is difficult to achieve accurate compensation.

### SUMMARY

The present disclosure provides a half-bridge control circuit, an AHB, a device, and a method, and solves the technical problem of difficulty in determining a turn-off time of a switching tube in a half-bridge circuit in the related art.

In order to achieve the above objective, the present disclosure adopts the following technical solutions.

In a first aspect, embodiments of the present disclosure provide a half-bridge control circuit for driving a half-bridge circuit in an AHB and a synchronous rectifier tube connected in series with a secondary winding of a transformer in the AHB. The half-bridge circuit includes a first switching tube and a second switching tube connected in series between an input capacitor and a first reference ground, a first end of the first switching tube is connected to one end of the input capacitor, the other end of the input capacitor is connected to the first reference ground, a second end of the first switching tube is connected to a first end of the second switching tube, a second end of the second switching tube is connected to the first reference ground. The half-bridge control circuit includes a primary controller unit, an isolated communication unit, and a secondary controller unit. The primary controller unit communicates with the secondary controller unit through the isolated communication unit, and the primary controller unit is configured to drive the first switching tube and the second switching tube to conduct in different time periods. The secondary controller unit is configured to drive the synchronous rectifier tube to conduct or turn off. In one switching cycle of the AHB, the secondary controller unit is configured to determine a turn-off time of the second switching tube according to an operating mode of the AHB and a current zero-crossing time of the synchronous rectifier tube, and send a first turn-off signal to the primary controller unit through the isolated communication unit at the turn-off time. The first turn-off signal is configured to trigger the primary controller unit to turn off the second switching tube. The primary controller unit is configured to control the second switching tube to turn off in response to the first turn-off signal.

In the half-bridge control circuit provided by the embodiments of the present disclosure, since the secondary controller unit may communicate with the primary controller unit through the isolated communication unit, the primary controller unit may determine the turn-off time of the second switching tube based on the current zero-crossing time of the synchronous rectifier tube, and send the first turn-off signal for triggering the primary controller unit to turn off the second switching tube to the primary controller unit by using the isolated communication unit at the determined turn-off time of the second switching tube, so that the primary controller unit controls the second switching tube to turn off at the turn-off time of the second switching tube. Compared with the related art, the solution is relatively simple and accurate to determine the turn-off time of the second switching tube and is easy to implement.

In one possible implementation of the present disclosure, the half-bridge control circuit includes a primary second drive unit connected to the primary controller unit. The primary second drive unit is further connected to a third end of the second switching tube, and the primary controller unit is configured to generate, after receiving the first turn-off signal, a drive signal for driving the second switching tube to turn off according to the first turn-off signal, and then transmit the drive signal to the primary second drive unit, so that the primary second drive unit drives the second switching tube to turn off by using the drive signal.

In one possible implementation of the present disclosure, the AHB operates in a CrM, and the secondary controller unit is configured to use the current zero-crossing time of the synchronous rectifier tube as a pre-turn-off time of the second switching tube, and delay the pre-turn-off time by a first duration as the turn-off time of the second switching tube. The first duration is adjusted according to whether ZVS of the first switching tube is achieved in each switching cycle. After the current zero-crossing time of the synchronous rectifier tube, the second switching tube is delayed for the first duration to conduct, so that an excitation inductor of the transformer generates a negative current, which is beneficial to achieving the ZVS of the first switching tube in the next switching cycle in the CrM, and reducing the circulating current loss and switching loss of a resonant cavity of the AHB.

In one possible implementation of the present disclosure, the AHB operates in a DCM, and the secondary controller unit is configured to use the current zero-crossing time of the synchronous rectifier tube as the turn-off time of the second switching tube.

In one possible implementation of the present disclosure, the isolated communication unit includes, but is not limited to, isolation manners such as capacitive isolation, magnetic isolation, and optical coupling isolation.

In one possible implementation of the present disclosure, the secondary controller unit is configured to maintain the first duration unchanged in a case that the ZVS of the first switching tube is achieved in the previous switching cycle, and increase the first duration in a case that the ZVS of the first switching tube is not achieved in the previous switching cycle.

In one possible implementation of the present disclosure, the secondary controller unit is configured to: before the first switching tube is turned on, on the condition that a voltage at a first end of the synchronous rectifier tube is lower than the voltage at the first end of the synchronous rectifier tube in a case that the first switching tube is turned on in the previous switching cycle, increase the first duration until, in a case that the first switching tube is turned on, the voltage at the first end of the synchronous rectifier tube is equal to the voltage at the first end of the synchronous rectifier tube in a case that the first switching tube is turned on, and the first duration is no longer increased.

In one possible implementation of the present disclosure, the half-bridge control circuit further includes a secondary first sampling unit connected to the secondary controller unit. The secondary first sampling unit is configured to collect the voltage at the first end of the synchronous rectifier tube before and in a case that the first switching tube is turned on, and transmit the collected voltage at the first end of the synchronous rectifier tube to the secondary controller unit, so that the secondary controller unit determines whether the ZVS of the first switching tube is achieved according to the voltage at the first end of the synchronous rectifier tube collected by the secondary first sampling unit, and determines whether to increase the first duration according to whether the ZVS of the first switching tube is achieved.

In one possible implementation of the present disclosure, in a case that the AHB operates in the CrM, the primary controller unit is further configured to drive the first switching tube to conduct after a first dead-time interval has elapsed from the time when the second switching tube is turned off, so as to facilitate achieving the ZVS of the first switching tube.

In one possible implementation of the present disclosure, the secondary controller unit is further configured to send the first dead-time interval to the primary controller unit through the isolated communication unit while sending the first turn-off signal, so as to facilitate the primary controller unit to determine to drive the first switching tube to conduct after the first dead-time interval has elapsed from the time when the second switching tube is turned off, thereby achieving the ZVS of the first switching tube.

In one possible implementation of the present disclosure, in a case that the AHB operates in the CrM, the secondary controller unit is further configured to send a conducting signal to the primary controller unit through the isolated communication unit after the first dead-time interval has elapsed from the time when the first turn-off signal is sent. The conducting signal is configured to trigger the primary controller unit to conduct the first switching tube.

In one possible implementation of the present disclosure, the half-bridge control circuit further includes a secondary first drive unit connected to a third end of the synchronous rectifier tube, the second first drive unit being further connected to the secondary controller unit. The secondary controller unit is further configured to drive the synchronous rectifier tube to turn on for a second duration through the secondary first drive unit before the first switching tube is turned on, and send a first turn-on signal to the primary controller unit through the isolated communication unit after the synchronous rectifier tube is turned on for the second duration. The first turn-on signal is configured to trigger the first switching tube to conduct. The primary controller unit is further configured to drive the first switching tube to conduct after a second dead-time interval has elapsed in response to the first turn-on signal. According to the solution, the ZVS of the first switching tube is achieved by conducting the synchronous rectifier tube in advance before conducting the first switching tube, and reversely exciting the excitation inductor.

In one possible implementation of the present disclosure, the half-bridge control circuit further includes the secondary first drive unit connected to the third end of the synchronous rectifier tube, the second first drive unit being further connected to the secondary controller unit. The secondary controller unit is further configured to drive the synchronous rectifier tube to turn on for the second duration through the secondary first drive unit before the first switching tube is turned on, and send the first turn-on signal to the primary controller unit through the isolated communication unit after the synchronous rectifier tube is turned on for the second duration and the second dead-time interval has elapsed. The primary controller unit is further configured to drive the first switching tube to turn on in response to the first conducting signal.

In one possible implementation of the present disclosure, the secondary controller unit is further configured to send a second turn-on signal to the primary controller unit through the isolated communication unit before the first switching tube is turned on again in the next switching cycle. The second turn-on signal is configured to trigger the primary controller unit to control the second switching tube to conduct for the second duration. The primary controller unit is further configured to control the second switching tube to conduct for the second duration in response to the second turn-on signal, and control the first switching tube to conduct after the second switching tube is conducted for the second duration and the second dead-time interval has elapsed.

In one possible implementation of the present disclosure, the second duration is calculated by an input voltage sampled by the secondary controller unit through the secondary first sampling unit and output voltage information of the transformer.

In one possible implementation of the present disclosure, the half-bridge control circuit further includes the secondary first sampling unit connected to the secondary controller unit. The secondary first sampling unit is configured to collect the voltage at the first end of the synchronous rectifier tube before and in a case that the first switching tube is turned on. The secondary controller unit is configured to: in a case that the first switching tube is about to turn on, on the condition that the voltage at the first end of the synchronous rectifier tube is lower than the voltage at the first end of the synchronous rectifier tube in a case that the first switching tube is turned on in the previous switching cycle, increase the second duration until, in a case that the first switching tube is turned on, the voltage at the first end of the synchronous rectifier tube is equal to the voltage at the first end of the synchronous rectifier tube in a case that the first switching tube is turned on, and the second duration is no longer increased.

In one possible implementation of the present disclosure, the secondary controller unit is configured to maintain the second duration unchanged in a case that the ZVS of the first switching tube is achieved in the previous switching cycle, and increase the second duration in a case that the ZVS of the first switching tube is not achieved in the previous switching cycle.

In one possible implementation of the present disclosure, the half-bridge control circuit further includes a primary sampling unit. The primary sampling unit is connected to the primary controller unit, and is configured to collect current information of the resonant cavity in a case that the first switching tube is turned on in one switching cycle, or is configured to collect the current information of the resonant cavity in a case that the first switching tube is turned on and current information of the resonant cavity in a case that the second switching tube is turned on in one switching cycle.

In one possible implementation of the present disclosure, the AHB further includes a sampling resistor. A second end of the second switching tube is connected to a first end of the sampling resistor, a second end of the sampling resistor is connected to the first reference ground, and the primary sampling unit is connected to the first end of the sampling resistor. The primary sampling unit is configured to collect the current information of the resonant cavity in a case that the first switching tube is conducted in one switching cycle.

In one possible implementation of the present disclosure, the AHB further includes a resonant inductor and a resonant capacitor. The second switching tube is connected in parallel with the resonant cavity formed by the resonant inductor, a primary winding of the transformer, and the resonant capacitor; or, the first switching tube is connected in parallel with the resonant cavity formed by the resonant inductor, the primary winding of the transformer, and the resonant capacitor.

In one possible implementation of the present disclosure, the AHB further includes the sampling resistor, the resonant inductor, and the resonant capacitor. The second end of the second switching tube and the first end of the sampling resistor are connected to the first reference ground, the second switching tube is connected in parallel with the resonant cavity formed by the resonant inductor, the primary winding of the transformer, and the resonant capacitor, the primary sampling unit is coupled to the second end of the second switching tube, and the primary sampling unit is configured to collect the current information of the resonant cavity in a case that the first switching tube is conducted and the current information of the resonant cavity in a case that the second switching tube is conducted in one switching cycle.

In one possible implementation of the present disclosure, the AHB further includes the resonant inductor, a resonant cavity current sampling unit, and the resonant capacitor. The second end of the second switching tube is connected to the first reference ground, the second switching tube is connected in parallel with the resonant cavity formed by the resonant inductor, the primary winding of the transformer, and the resonant capacitor, the primary sampling unit is connected to the resonant cavity current sampling unit, and the resonant cavity current sampling unit is connected between the resonant capacitor and the primary winding.

In one possible implementation of the present disclosure, the third end of the synchronous rectifier tube is connected to the secondary controller unit through the secondary first drive unit, the first end of the synchronous rectifier tube is connected to a non-dot end of the secondary winding of the transformer, a second end of the synchronous rectifier tube is connected to a first end of an output capacitor of the AHB, and a second end of the output capacitor is connected to a dot end of the secondary winding; or, the second end of the synchronous rectifier tube is connected to the dot end of the secondary winding of the transformer, the first end of the synchronous rectifier tube is connected to the second end of the output capacitor of the AHB, and the first end of the output capacitor is connected to the non-dot end of the secondary winding.

In a second aspect, the embodiments of the present disclosure provide a control method for an AHB. The method is applied to the AHB. The AHB includes a half-bridge circuit, a transformer, and a half-bridge control circuit. The half-bridge circuit includes a first switching tube and a second switching tube connected in series between an input capacitor and a first reference ground. The half-bridge control circuit includes a primary controller unit and a secondary controller unit. The primary controller unit communicates with the secondary controller unit through an isolated communication unit, the primary controller unit is configured to drive the first switching tube and the second switching tube, and the secondary controller unit is configured to drive a synchronous rectifier tube connected in series with a secondary winding of the transformer. In one switching cycle of the AHB, the secondary controller unit determines a turn-off time of the second switching tube according to an operating mode of the AHB and a current zero-crossing time of the synchronous rectifier tube. The secondary controller unit sends a first turn-off signal to the primary controller unit through the isolated communication unit at the turn-off time of the second switching tube. The first turn-off signal is configured to trigger the primary controller unit to turn off the second switching tube. The primary controller unit controls the second switching tube to turn off in response to the first turn-off signal.

In one possible implementation of the present disclosure, the method provided by the embodiments of the present disclosure further includes the following operation.

In a case that the AHB operates in a CrM, the primary controller unit controls the first switching tube to conduct after a first dead-time interval has elapsed from the time when the second switching tube is turned off.

In one possible implementation of the present disclosure, the method provided by the embodiments of the present disclosure further includes that: the primary controller unit further receives the first turn-off signal from the secondary controller unit through the isolated communication unit, and further receives the first dead-time interval.

In one possible implementation of the present disclosure, the operation that in one switching cycle of the AHB, the secondary controller unit determines the turn-off time of the second switching tube according to the operating mode of the AHB and the current zero-crossing time of the synchronous rectifier tube includes that: the AHB operates in the CrM, and the secondary controller unit uses the current zero-crossing time of the synchronous rectifier tube as a pre-turn-off time of the second switching tube, and delays the pre-turn-off time by a first duration as the turn-off time of the second switching tube. The first duration is adjusted according to whether ZVS of the first switching tube is achieved in each switching cycle.

In one possible implementation of the present disclosure, the operation that in one switching cycle of the AHB, the secondary controller unit determines the turn-off time of the second switching tube according to the operating mode of the AHB and the current zero-crossing time of the synchronous rectifier tube includes that: the AHB operates in a DCM, and the secondary controller unit uses the current zero-crossing time of the synchronous rectifier tube as the turn-off time of the second switching tube.

In one possible implementation of the present disclosure, the half-bridge control circuit further includes a secondary first sampling unit connected to the secondary controller unit. The secondary first sampling unit is configured to collect a voltage at a first end of the synchronous rectifier tube before and in a case that the first switching tube is turned on. Before the first switching tube is turned on, on the condition that the voltage at the first end of the synchronous rectifier tube is lower than the voltage at the first end of the synchronous rectifier tube in a case that the first switching tube is turned on in the previous switching cycle, the secondary controller unit increases the first duration until, in a case that the first switching tube is turned on, the voltage at the first end of the synchronous rectifier tube is equal to the voltage at the first end of the synchronous rectifier tube in a case that the first switching tube is turned on, and the secondary controller unit maintains the first duration no longer increasing.

In one possible implementation of the present disclosure, the half-bridge control circuit further includes a secondary first drive unit connected to a third end of the synchronous rectifier tube, the secondary first drive unit being further connected to the secondary controller unit. The secondary controller unit further drives the synchronous rectifier tube to turn on for a second duration through the secondary first drive unit before the first switching tube is turned on in the next switching cycle, and sends a first turn-on signal to the primary controller unit through the isolated communication unit after the synchronous rectifier tube is turned on for the second duration. The first turn-on signal is configured to trigger the first switching tube to conduct, and the primary controller unit controls the first switching tube to conduct after a second dead-time interval has elapsed in response to the first turn-on signal. In this way, the first switching tube and the synchronous rectifier tube may be prevented from being conducted at the same time.

In one possible implementation of the present disclosure, after the second switching tube is turned off, the method provided by the embodiments of the present disclosure may further include that: the secondary controller unit sends a second turn-on signal to the primary controller unit through the isolated communication unit before the first switching tube is turned on again in the next switching cycle, where the second turn-on signal is configured to trigger the primary controller unit to control the second switching tube to conduct for the second duration; and the primary controller unit controls the second switching tube to conduct for the second duration in response to the second turn-on signal, and controls the first switching tube to conduct after the second switching tube is conducted for the second duration and the second dead-time interval has elapsed.

In one possible implementation of the present disclosure, the second duration is calculated by an input voltage sampled by the secondary controller unit through the secondary first sampling unit and output voltage information of the transformer.

In one possible implementation of the present disclosure, the half-bridge control circuit further includes the secondary first sampling unit connected to the secondary controller unit. The secondary first sampling unit is configured to collect the voltage at the first end of the synchronous rectifier tube before and in a case that the first switching tube is turned on. The method provided by the embodiments of the present disclosure may further include that: the secondary controller unit is configured to: if, in a case that the first switching tube is about to turn on, the voltage at the first end of the synchronous rectifier tube is lower than the voltage at the first end of the synchronous rectifier tube in a case that the first switching tube is turned on in the previous switching cycle, increase the second duration until, in a case that the first switching tube is turned on, the voltage at the first end of the synchronous rectifier tube is equal to the voltage at the first end of the synchronous rectifier tube in a case that the first switching tube is turned on, and the second duration is no longer increased.

In a third aspect, the embodiments of the present disclosure provide a chipset, which includes the half-bridge control circuit described in the first aspect or various possible implementations of the first aspect, or the AHB described in the second aspect.

As an example, the chipset includes one or more chips.

A synchronous rectifier tube, a half-bridge circuit, and the half-bridge control circuit in the AHB may exist in separate chips respectively.

In a fourth aspect, the embodiments of the present disclosure provide an AHB, which includes: a transformer, including a primary winding, an auxiliary winding, and a secondary winding; a synchronous rectifier tube connected in series with the secondary winding; a half-bridge circuit, including a first switching tube and a second switching tube connected in series between an input capacitor and a first reference ground; and the half-bridge control circuit described in the first aspect or various possible implementations of the first aspect.

In a fifth aspect, the embodiments of the present disclosure provide a power supply device, which includes the AHB as described above.

In a sixth aspect, the embodiments of the present disclosure provide an electronic device, which includes the power supply device as described above.

In one possible implementation of the present disclosure, the electronic device is an adapter or a charger.

### BRIEF DESCRIPTION OF THE DRAWINGS

FIG. 1 is a control block diagram of an AHB provided in the related art.

FIG. 2 is an operating waveform 1 of an AHB shown in FIG. 1 operating in a CrM.

FIG. 3 is an operating waveform 1 of an AHB shown in FIG. 1 operating in a CrM.

FIG. 4 is an operating waveform of an AHB shown in FIG. 1 operating in a DCM.

FIG. 5 to FIG. 9 are schematic structural diagrams of an AHB according to an embodiment of the present disclosure.

FIG. 10 is an operating waveform 1 of an AHB operating in a CrM according to an embodiment of the present disclosure.

FIG. 11 is an operating waveform 2 of an AHB operating in a CrM according to an embodiment of the present disclosure.

FIG. 12 to FIG. 14 respectively show operating waveforms of an AHB operating in a DCM according to an embodiment of the present disclosure.

FIG. 15 is a schematic flowchart of a control method for an AHB according to an embodiment of the present disclosure.

### DETAILED DESCRIPTION OF THE EMBODIMENTS

“Soft switching” refers to ZVS or zero current switching, which uses a resonance principle to change a voltage (or current) of a switching tube of a switching converter according to the sinusoidal (or quasi-sinusoidal) law. In a case that the voltage crosses zero, a device is turned on (or in a case that the current naturally crosses zero, the device is turned off), so that the switching loss is zero, thereby improving the efficiency and switching frequency of the converter and reducing the size of a transformer and an inductor.

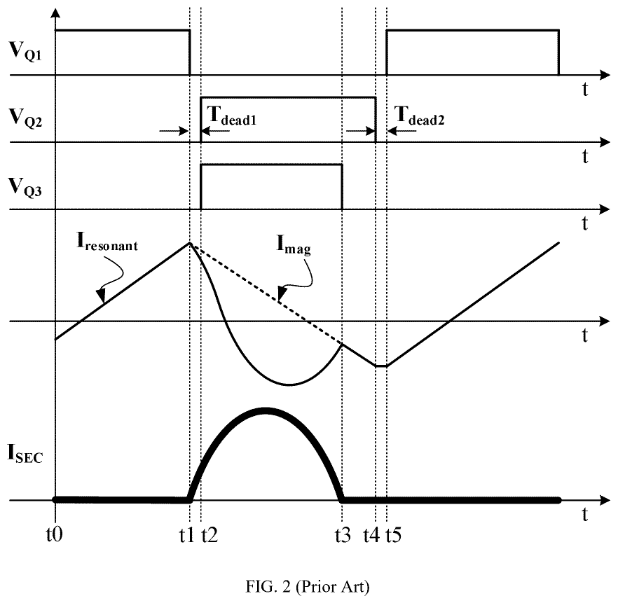

A CrM means that a first switching tube and a second switching tube in a half-bridge circuit are conducted in different time periods, and the other switching tube is controlled to conduct after a certain dead-time interval has elapsed from the time when one switching tube is turned off. As shown in FIG. 2, the second switching tube Q₂ is controlled to conduct after a certain dead-time interval has elapsed from the time when the first switching tube Q₁ is turned off, and then the first switching tube Q₁ is controlled to conduct again after a certain dead-time interval has elapsed from the time when the second switching tube Q₂ is turned off.

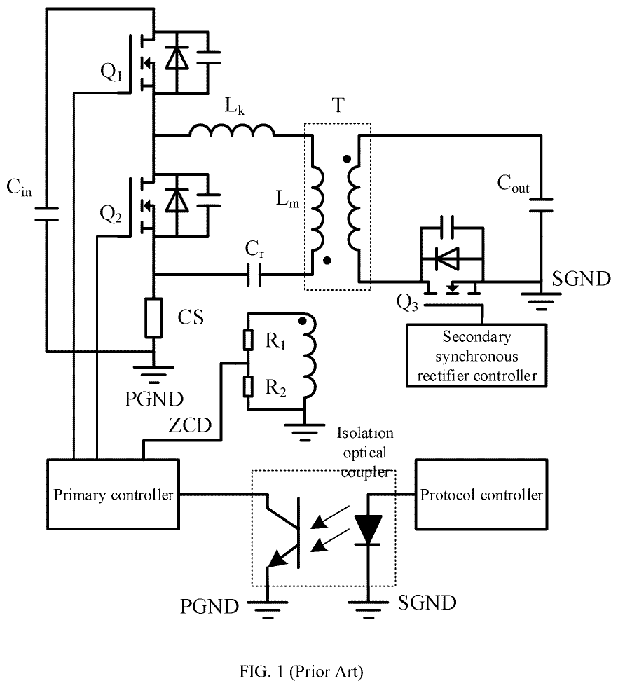

As shown in FIG. 1, FIG. 1 is a structure of an AHB in the related art. As shown in FIG. 1, the AHB includes a half-bridge circuit, a primary controller, an isolation optical coupler, a primary protocol controller, a secondary synchronous rectifier controller, and a transformer T. The transformer T includes a primary winding Lₘ, an auxiliary winding, and a secondary winding.

The half-bridge circuit includes a first switching tube Q₁ and a second switching tube Q₂ connected in series between an input capacitor Cᵢₙ and a first reference ground PGND. A first end of the first switching tube Q₁ is connected to one end of the input capacitor Cᵢₙ. The other end of the input capacitor Cᵢₙ is connected to the first reference ground PGND. A second end of the first switching tube Q₁ is connected to a first end of the second switching tube Q₂. A second end of the second switching tube Q₂ is connected to the first reference ground PGND through a sampling resistor CS. Third ends of the first switching tube Q₁ and the second switching tube Q₂ are both connected to the primary controller. As shown in FIG. 1, the second switching tube Q₂ is connected in parallel with a resonant cavity formed by a resonant inductor Lₖ, an excitation winding Lₘ (i.e., the primary winding of the transformer T) and a resonant capacitor Cᵣ. A synchronous rectifier tube Q₃ is connected in series between the secondary winding of the transformer T and an output Cₒᵤₜ. The synchronous rectifier tube Q₃ is controlled by a secondary synchronous rectifier controller.

In addition, as shown in FIG. 1, the auxiliary winding is further connected in series with a resistor R₁ and a resistor R₂, and the primary controller is connected between the resistor R₁ and the resistor R₂.

In the structure shown in FIG. 1, the secondary protocol controller transmits a feedback signal (output power information) to the primary controller in a unidirectional manner through the isolation optical coupler, so that the primary controller adjusts conducting times of the first switching tube Q₁ and the second switching tube Q₂ according to the output power information. The secondary synchronous rectifier controller turns on and off by detecting switching tube information of the synchronous rectifier tube Q₃.

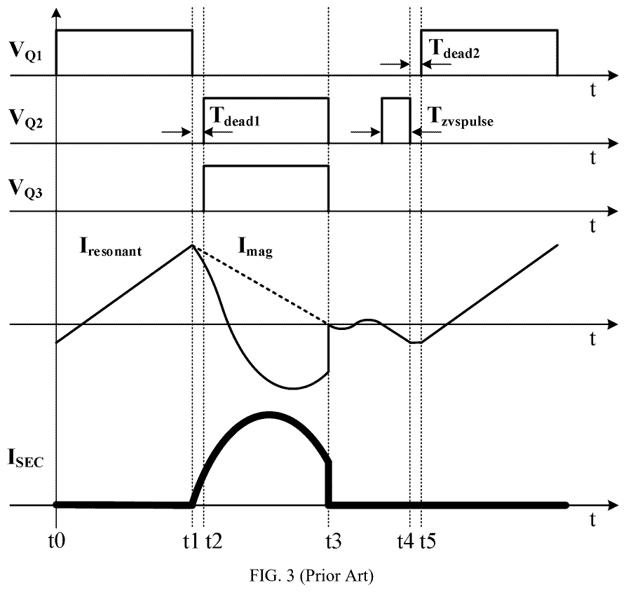

The AHB may operate in either CrM or DCM. As shown in FIG. 2 and FIG. 3, which are operating waveforms of the AHB in the CrM, VQ₁, VQ₂ and VQ₃ are drive voltage signal waveforms of the first switching tube Q₁, the second switching tube Q₂, and the synchronous rectifier tube Q₃, respectively.

As shown in FIG. 2, the first switching tube Q₁ is turned on at time to and turned off at time t1. During the time period from t0 to t1, the primary controller controls the first switching tube Q₁ to conduct and controls the second switching tube Q₂ to turn off, a resonant cavity current Iᵣₑₛₒₙₐₙₜ is a positive current, currents of the resonant inductor Lᵣ and the excitation inductor Lₘ increase, and the resonant capacitor Cᵣ stores energy.

After the first switching tube Q₁ is conducted for a certain duration (i.e., the time period from t0 to t1), the primary controller controls the first switching tube Q₁ to turn off (that is, the primary controller controls the first switching tube Q₁ to turn off at time t1), and after a certain dead-time interval T_{dead1} has elapsed, i.e., at time t2, the primary controller controls the second switching tube Q₂ to turn on. Since the second switching tube Q₂ is conducted and the first switching tube Q₁ is turned off, the resonant capacitor Cᵣ resonates with the resonant inductor Lᵣ, and the transformer T transmits energy to the synchronous rectifier tube Q₃. At this time, the synchronous rectifier tube Q₃ is turned on, a current I_{mag} of the excitation inductor of the transformer T linearly decreases, and the excitation inductor Lₘ transmits energy to the secondary. ZVS of the first switching tube Q₁ may be achieved by extending a period of time based on a zero-crossing time of the excitation current.

In the waveform shown in FIG. 2, in order to achieve the ZVS of the first switching tube Q₁, the second switching tube Q₂ may be controlled to extend the conducting for a period of time based on the zero-crossing time of the excitation current. However, in the operating waveform shown in FIG. 3, the second switching tube Q₂ may be controlled to conduct for a period of time (e.g., T_{ZVSpulse}) in advance before the first switching tube Q₁ is conducted to achieve the ZVS of the first switching tube Q₁.

The difference between FIG. 2 and FIG. 3 is whether the current in the resonant cavity performs complete power transmission. For example, as shown in FIG. 2, the current in the resonant cavity performs complete power transmission, while the current in the resonant cavity in the waveform shown in FIG. 3 does not perform complete power transmission. Since the second switching tube Q₂ and the synchronous rectifier tube Q₃ are turned off at time t3, the current in the resonant cavity is forced to drop to 0.

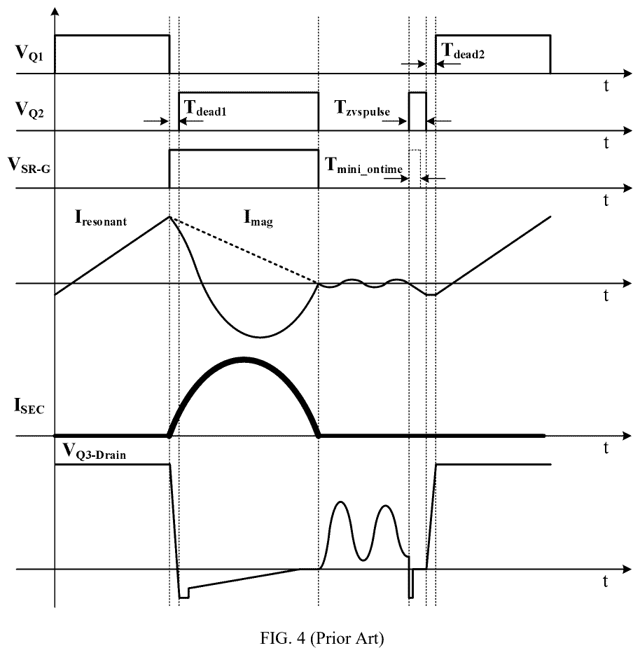

FIG. 4 is an operating waveform of an AHB operating in a DCM. As shown in FIG. 4, the primary controller may use the zero-crossing time of the excitation current of the transformer T as a turn-off time of the second switching tube Q₂, or set a fixed turn-off time inside the primary controller, and the primary controller dynamically compensates for the above fixed turn-off time according to different output voltages detected by the auxiliary winding of the transformer T.

However, at present, the primary controller detects excitation and demagnetization processes of the transformer T through ZCD of the auxiliary winding. Based on the volt-second balance of the transformer T, the primary controller obtains the zero-crossing time of the excitation current of the transformer by internal calculation. However, due to a sampling error, it is difficult to accurately calculate the turn-off time. Under dynamic conditions, the volt-second balance of the transformer T is not established. A volt-second balance circuit inside the primary controller is complex, which increases the complexity of the control circuit. In addition, the fixed turn-off time is set inside the primary controller, which is difficult to accurately match for applications in different power ranges, and the dynamic compensation under a wide range of output voltages is difficult to achieve accurate compensation. In addition, the transformer T is short-circuited in a case that the second switching tube Q₂ is turned on, and the resonant capacitor Cᵣ resonates with the resonant inductor Lᵣ. During the resonance period, the current of the excitation inductor of the transformer T cannot be directly detected by the circuit, so that the turn-off time of the second switching tube Q₂ is difficult to determine.

Based on this, the embodiments of the present disclosure provide a half-bridge control circuit. Since a secondary controller unit may communicate with a primary controller unit through an isolated communication unit, the primary controller unit may determine the turn-off time of the second switching tube Q₂ based on the current zero-crossing time of the synchronous rectifier tube Q₃, and send a first turn-off signal for triggering the primary controller unit to turn off the second switching tube Q₂ to the primary controller unit by using the isolated communication unit at the determined turn-off time of the second switching tube Q₂. Compared with the related art, the solution is relatively simple and accurate to determine the turn-off time of the second switching tube Q₂ and is easy to implement.

On the other hand, as shown in FIG. 4, after a dead-time interval T_{dead1} has elapsed from the time when the first switching tube Q₁ is turned off, the primary controller controls the second switching tube Q₂ to conduct. At time t1, since the secondary synchronous rectifier controller and the primary controller cannot communicate, in a case that the second switching tube Q₁ is turned off, the secondary synchronous rectifier controller controls the synchronous rectifier tube Q₃ to conduct. Then, in order to achieve the ZVS of the first switching tube Q₁, before the first switching tube Q₁ is turned on (before time t6), the primary controller controls the time in a case that the second switching tube Q₂ is turned on for T_{ZVSpulse} first, i.e., the time in a case that the second switching tube Q₂ is turned on for T_{ZVSpulse} at time t4 to t5, the current of the excitation inductor crosses zero and becomes negative to discharge a junction capacitor of the first switching tube Q₁ and charge the junction capacitor of the second switching tube Q₂, thereby achieving the ZVS of the first switching tube Q₁. However, in the DCM, in order to achieve the ZVS of the first switching tube Q₁, the second switching tube Q₂ needs to turn on once before the first switching tube Q₁ is turned on. At this time, a leakage inductor of the secondary winding of the transformer T resonates with the junction capacitor, the voltage across the secondary winding may be higher than the output voltage for a short time, and the synchronous rectifier tube Q₃ is prone to secondary turn-on. If the minimum conducting time of the synchronous rectifier tube Q₃ is greater than a T_{ZVSpulse} pulse width time, there is a risk that the first switching tube Q₁ and the synchronous rectifier tube Q₃ are turned on at the same time, which damages a switch device. Based on this, the embodiments of the present disclosure further provide a method. Since the primary controller unit may communicate with the secondary controller unit, in the DCM, before the first switching tube Q₁ is conducted again, the synchronous rectifier tube Q₃ may be controlled to conduct for a T_{ZVSpulse} duration first. T_{ZVSpulse} is achieved by the synchronous rectifier tube Q₃. After T_{ZVSpulse} ends and a dead-time interval T_{dead2} has elapsed, the secondary controller unit sends a turn-on signal Tₚᵤₗₛₑ₂ to the primary controller through the isolated communication unit. The turn-on signal Tₚᵤₗₛₑ₂ is configured to trigger the primary controller unit to control the first switching tube Q₁ to conduct, and this turn-on timing fundamentally solves the problem that the first switching tube Q₁ and the synchronous rectifier tube Q₃ are turned on at the same time.

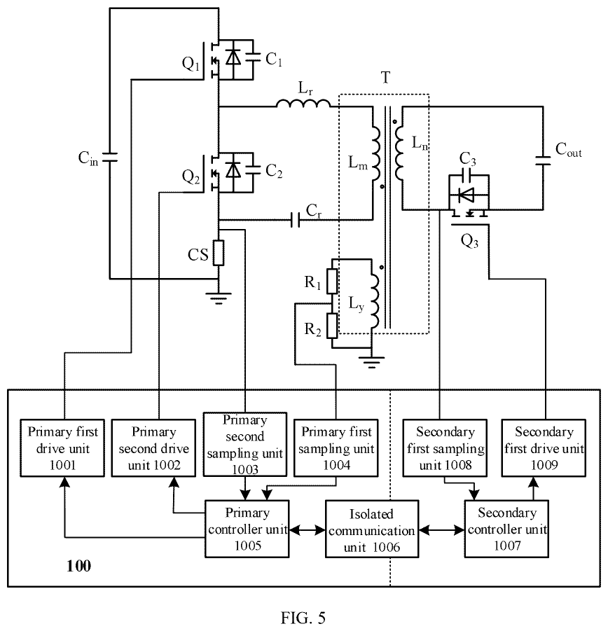

As shown in FIG. 5, FIG. 5 is a schematic structural diagram of a half-bridge control circuit 100 according to an embodiment of the present disclosure. The half-bridge control circuit 100 is configured to drive a half-bridge circuit in an AHB and a synchronous rectifier tube Q₃ connected in series with a secondary winding of a transformer T in the AHB. The half-bridge circuit includes a first switching tube Q₁ and a second switching tube Q₂ connected in series between an input capacitor Cᵢₙ and a first reference ground. The half-bridge control circuit 100 includes a primary controller unit 1005, an isolated communication unit 1006, and a secondary controller unit 1007. The primary controller unit 1005 communicates with the secondary controller unit 1007 through the isolated communication unit 1006. The primary controller unit 1005 is configured to control the first switching tube Q₁ and the second switching tube Q₂ to conduct in different time periods in one switching cycle.

The secondary controller unit 1007 is configured to drive the synchronous rectifier tube Q₃ to conduct or turn off in one switching cycle.

In one switching cycle of the AHB, the secondary controller unit 1007 is configured to determine a turn-off time of the second switching tube Q₂ according to an operating mode of the AHB and a current zero-crossing time of the synchronous rectifier tube Q₃, and send a first turn-off signal to the primary controller unit 1005 through the isolated communication unit 1006 at the turn-off time of the second switching tube Q₂. The first turn-off signal is configured to trigger the primary controller unit 1005 to turn off the second switching tube Q₂. The primary controller unit 1005 is further configured to control the second switching tube Q₂ to turn off in response to the first turn-off signal.

In the half-bridge control circuit provided by the embodiments of the present disclosure, since the secondary controller unit may communicate with the primary controller unit through the isolated communication unit, the primary controller unit may determine the turn-off time of the second switching tube Q₂ based on the current zero-crossing time of the synchronous rectifier tube Q₃, and send the first turn-off signal for triggering the primary controller unit to turn off the second switching tube Q₂ to the primary controller unit by using the isolated communication unit at the determined turn-off time of the second switching tube Q₂. Compared with the related art, the solution is relatively simple and accurate to determine the turn-off time of the second switching tube Q₂ and is easy to implement.

In one possible embodiment of the present disclosure, the secondary controller unit 1007 is configured to drive the synchronous rectifier tube Q₃ to conduct during a conducting time of the second switching tube Q₂.

It is understandable that the conducting time of the synchronous rectifier tube Q₃ is equal to or less than that of the second switching tube Q₂.

As an example, as shown in FIG. 5, a first end of the first switching tube Q₁ is coupled to one end of the input capacitor Cᵢₙ. The other end of the input capacitor Cᵢₙ is grounded, for example, the other end of the input capacitor Cᵢₙ and a sampling resistor CS are grounded. A second end of the first switching tube Q₁ is connected to a first end of the second switching tube Q₂. A second end of the second switching tube Q₂ is grounded. A third end of the first switching tube Q₁ and a third end of the second switching tube Q₂ are respectively configured to receive drive signals. For example, the third end of the first switching tube Q₁ is configured to receive a drive signal 1 (e.g., a PWM signal 1). The third end of the second switching tube Q₂ is configured to receive a drive signal 2 (e.g., a PWM signal 2).

Specifically, the third end of the first switching tube Q₁ and the third end of the second switching tube Q₂ are respectively connected to the half-bridge control circuit 100, and the half-bridge control circuit 100 is configured to output the PWM signal 1 for driving the first switching tube Q₁ and the PWM signal 2 for driving the second switching tube Q₂. For example, the half-bridge control circuit 100 is configured to output a first level signal for driving the first switching tube Q₁ to conduct, and output a second level signal for driving the first switching tube Q₁ to turn off. Exemplarily, the first level signal is a high-level signal, and the second level signal is a low-level signal, which is not limited in the embodiments of the present disclosure.

For example, in the embodiments of the present disclosure, the first end of the switching tube/synchronous rectifier tube may refer to a drain of the switching tube/synchronous rectifier tube. The third end of the switching tube/synchronous rectifier tube may refer to a gate of the switching tube/synchronous rectifier tube. The second end of the switching tube/synchronous rectifier tube may refer to a source of the switching tube/synchronous rectifier tube.

In the same switching cycle, the first switching tube Q₁ and the second switching tube Q₂ are conducted in different time periods to transfer an input voltage Vᵢₙ from a primary side of the transformer T to a secondary side.

In one possible embodiment, the first switching tube Q₁, the second switching tube Q₂, and the synchronous rectifier tube Q₃ may be metal-oxide-semiconductor field-effect transistor devices. At the same time, the transistor may also be an insulated gate bipolar transistor device, an integrated gate rectifier thyristor device, a gate turn-off thyristor device, a silicon controlled rectifier device, a junction gate field effect transistor device, a Metal-Oxide-Semiconductor (MOS) controlled thyristor device, a gallium nitride-based power device, a silicon nitride-based power device, etc. No specific limits are made thereto in the embodiments of the present disclosure. In one possible embodiment, the first switching tube Q₁, the second switching tube Q₂, and the synchronous rectifier tube Q₃ respectively include a body diode.

In the structure shown in FIG. 5, a capacitor C₁, a capacitor C₂, and a capacitor C₃ are junction capacitors of the first switching tube Q₁, the second switching tube Q₂, and the synchronous rectifier tube Q₃, respectively.

Referring to FIG. 5, the primary side of the AHB includes a resonant inductor Lᵣ, an excitation inductor Lₘ (i.e., the primary winding of the transformer T, also referred to as a primary-side winding), and a resonant capacitor Cᵣ. The secondary side of the AHB includes an inductor Lₙ (i.e., the secondary winding or a secondary-side winding of the transformer T), the synchronous rectifier tube Q₃, and an output capacitor Cₒᵤₜ.

The resonant inductor Lᵣ, the excitation inductor Lₘ, and the resonant capacitor Cᵣ may form a resonant cavity of the AHB. The resonant inductor Lᵣ, the excitation inductor Lₘ, and the resonant capacitor Cᵣ are connected in series.

In practical applications, resonant cavity circuits of other structures may be provided according to specific circuit requirements.

Referring to FIG. 5, in one possible implementation of the present disclosure, a first end of the synchronous rectifier tube Q₃ is connected to a non-dot end of the secondary winding of the transformer, a second end of the synchronous rectifier tube Q₃ is connected to a first end of the output capacitor Cₒᵤₜ of the AHB, and the second end of the synchronous rectifier tube Q₃ is connected to the secondary controller unit 1007 through a secondary first drive unit 1009. A second end of the output capacitor Cₒᵤₜ is connected to a dot end of the secondary winding. Through the arrangement, low-side synchronous rectification may be achieved.

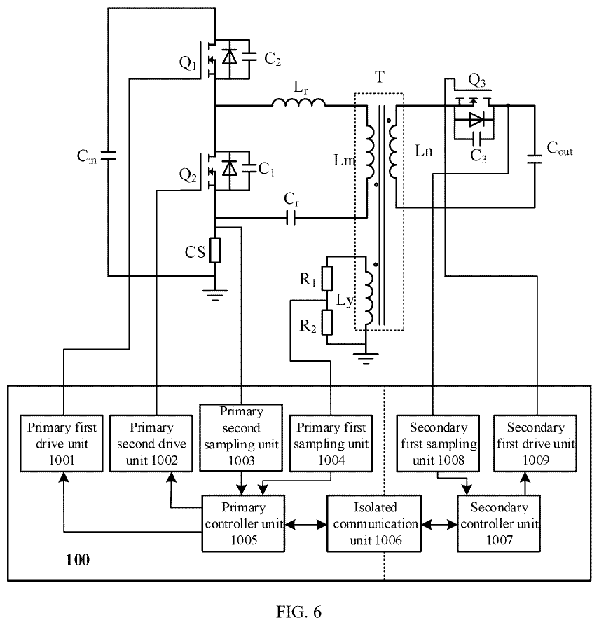

Referring to FIG. 6, which is a structure of another AHB according to an embodiment of the present disclosure, in the structure shown in FIG. 6, the second end of the synchronous rectifier tube Q₃ is connected to the dot end of the secondary winding, and the first end of the synchronous rectifier tube Q₃ is connected to the second end of the output capacitor Cₒᵤₜ of the secondary winding. The first end of the output capacitor Cₒᵤₜ is connected to the non-dot end of the secondary winding, and the second end of the synchronous rectifier tube Q₃ is connected to the secondary controller unit 1007 through the secondary first drive unit 1009. Through the arrangement, high-side synchronous rectification may be achieved.

In one possible embodiment, as shown in FIG. 5 to FIG. 9, the AHB provided by the embodiments of the present disclosure may further include the secondary first drive unit 1009. One end of the secondary first drive unit 1009 is connected to a third end of the synchronous rectifier tube Q₃, and the other end of the secondary first drive unit 1009 is connected to the secondary controller unit 1007. The secondary first drive unit 1009 is configured to drive the synchronous rectifier tube Q₃ to turn on or turn off based on the control of the secondary controller unit 1007.

For example, the secondary controller unit 1007 is configured to drive the synchronous rectifier tube Q₃ to turn on or turn off through the secondary first drive unit 1009.

For example, in a case that detecting a need to turn on the synchronous rectifier tube Q₃, the secondary controller unit 1007 controls the secondary first drive unit 1009 to generate a drive signal (e.g., the high-level signal) for driving the synchronous rectifier tube Q₃ to conduct. For example, in a case that detecting a need to turn off the synchronous rectifier tube Q₃, the secondary controller unit 1007 controls the secondary first drive unit 1009 to generate a drive signal (e.g., the low-level signal) for driving the synchronous rectifier tube Q₃ to turn off.

In one possible implementation of the present disclosure, the isolated communication unit includes, but is not limited to, isolation manners such as capacitive isolation, magnetic isolation, and optical coupling isolation.

Referring to FIG. 5 to FIG. 9, in one possible embodiment of the present disclosure, the AHB further includes a first resistor R₁ and a second resistor R₂. The first resistor R₁ and the second resistor R₂ are sequentially connected in series between a non-dot end and a dot end of an auxiliary winding L_{y}, and a connection node of the first resistor R₁ and the second resistor R₂ is connected to a primary sampling unit.

Optionally, in this embodiment, the voltage across the auxiliary winding L_{y} may be sampled by the primary sampling unit after being divided by the first resistor R₁ and the second resistor R₂. In addition, the half-bridge control circuit 100 may also directly sample the voltage across the auxiliary winding L_{y}.

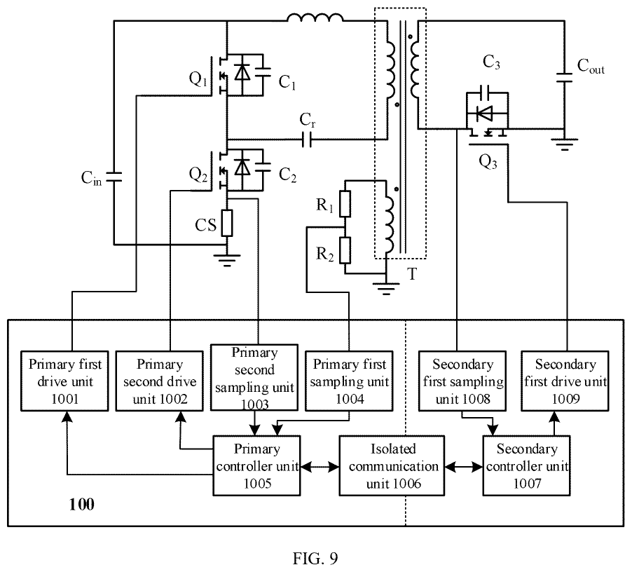

Referring to FIG. 9, in one possible embodiment of the present disclosure, the AHB further includes a sampling resistor CS. As shown in FIG. 5, the second end of the second switching tube Q₂ is connected to the first reference ground through the sampling resistor CS. That is, the second end of the second switching tube Q₂ is connected to one end of the sampling resistor CS, and the other end of the sampling resistor CS is connected to the first reference ground.

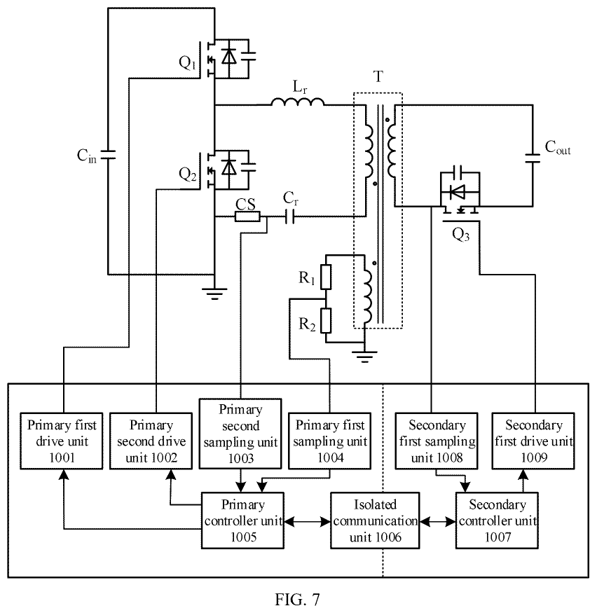

Referring to FIG. 7, FIG. 7 is a structure of another AHB according to the present disclosure. The difference between FIG. 7 and FIG. 5 is that in FIG. 5, the second end of the second switching tube Q₂ is connected to the first reference ground through the sampling resistor CS, while in FIG. 7, the second end of the second switching tube Q₂ is connected to the first reference ground, one end of the sampling resistor CS is connected to the second end of the second switching tube Q₂, and the other end of the sampling resistor CS is connected to the capacitor Cᵣ. In the solution shown in FIG. 5, the CS resistor samples current information of the resonant cavity in a case that the first switching tube Q₁ is conducted in one switching cycle. In the solution shown in FIG. 7, the CS resistor samples the current information of the resonant cavity in a case that the first switching tube Q₁ is conducted and the current information of the resonant cavity in a case that the second switching tube Q₂ is conducted in one switching cycle.

In one possible embodiment of the present disclosure, in the structure of the AHB shown in FIG. 5 to FIG. 8, the second switching tube Q₂ is connected in parallel with the resonant cavity in the AHB. Specifically, one end of the resonant inductor Lᵣ is connected to the drain of the second switching tube Q₂, and the other end of the resonant inductor Lᵣ is connected to the dot end of the excitation inductor Lₘ. One end of the resonant capacitor Cᵣ is connected to the non-dot end of the excitation inductor Lₘ, and the other end of the resonant capacitor Cᵣ is connected to the source of the second switching tube Q₂.

In one possible embodiment of the present disclosure, in the structure of the AHB shown in FIG. 9, the first switching tube Q₁ is connected in parallel with the resonant cavity in the AHB. Specifically, one end of the resonant inductor Lᵣ is connected to the drain of the first switching tube Q₁, and the other end of the resonant inductor Lᵣ is connected to the dot end of the excitation inductor Lₘ. One end of the resonant capacitor Cᵣ is connected to the non-dot end of the excitation inductor Lₘ, and the other end of the resonant capacitor Cᵣ is connected to the drain of the second switching tube Q₂.

The difference between the AHB shown in FIG. 9 and the AHB shown in FIG. 5 to FIG. 8 is that: in the embodiment shown in FIG. 9, in a case that the second switching tube Q₂ is turned on, the currents of the resonant inductor Lᵣ and the excitation inductor Lₘ increase, and the resonant capacitor Cᵣ stores energy, and in a case that the first switching tube Q₁ is turned on, the resonant capacitor Cᵣ resonates with the resonant inductor Lᵣ and the transformer T transmits energy to the secondary.

In one possible embodiment of the present disclosure, the half-bridge control circuit 100 further includes a primary drive unit and the primary sampling unit connected to the primary controller unit 1005.

The primary drive unit is configured to drive the first switching tube Q₁ and the second switching tube Q₂ respectively. The primary sampling unit is configured to collect the current information of the resonant cavity in a case that the first switching tube Q₁ and the second switching tube Q₂ are conducted respectively. Optionally, the primary sampling unit is further configured to collect the voltage across the auxiliary winding after being divided by the first resistor R₁ and the second resistor R₂.

For example, the primary drive unit may have two output ends, one of which is connected to the third end of the first switching tube Q₁ and the other is connected to the third end of the second switching tube Q₂.

As an example, as shown in FIG. 5 to FIG. 9, the primary drive unit may include a primary first drive unit 1001 and a primary second drive unit 1002.

The primary first drive unit 1001 is configured to drive the first switching tube Q₁, that is, an output end of the primary first drive unit 1001 is coupled to the third end of the first switching tube Q₁, and an input end of the primary first drive unit 1001 is connected to the primary controller unit 1005.

The primary second drive unit 1002 is configured to drive the second switching tube Q₂, that is, an output end of the primary second drive unit 1002 is coupled to the third end of the second switching tube Q₂, and an input end of the primary second drive unit 1002 is connected to the primary controller unit 1005. The primary second drive unit 1002 and the primary first drive unit 1001 both provide the high-level or low-level signals for the respective connected switching tubes based on the control of the primary controller unit 1005.

As an example, as shown in FIG. 5 to FIG. 9, the primary sampling unit may include a primary second sampling unit 1003.

In a case that the AHB adopts the structure shown in FIG. 5, the primary second sampling unit 1003 is connected to one end of the sampling resistor CS, which facilitates the primary second sampling unit 1003 to collect the current information of the resonant cavity in a case that the first switching tube Q₁ is conducted.

In a case that the AHB adopts the structure shown in FIG. 7, the primary second sampling unit 1003 is connected to a connection point of the sampling resistor CS and the capacitor Cᵣ, so that the primary second sampling unit 1003 not only collects the current information of the resonant cavity in a case that the first switching tube Q₁ is conducted and the second switching tube Q₂ is turned off, but also collects the current information of the resonant cavity in a case that the first switching tube Q₁ is turned off and the second switching tube Q₂ is conducted. That is, the primary second sampling unit 1003 may collect the current information of the resonant cavity in one complete switching cycle.

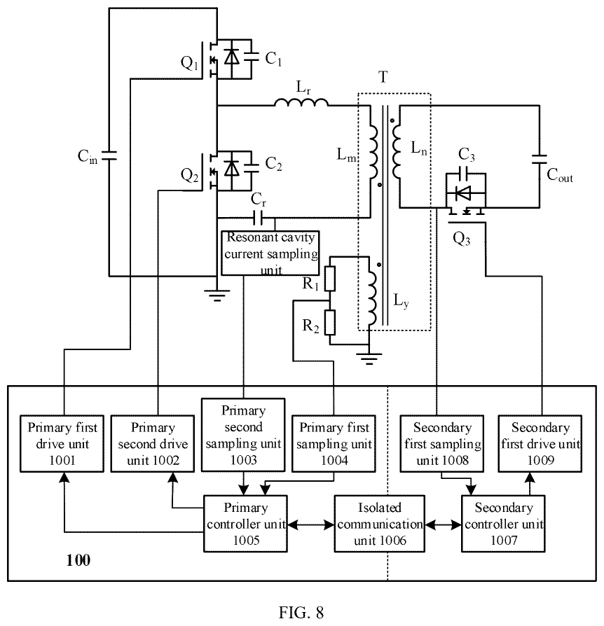

In a case that the AHB adopts the structure shown in FIG. 8, the primary second sampling unit 1003 is connected to a resonant cavity current sampling unit. The resonant cavity current sampling unit obtains the current information of the resonant cavity by using voltage information of the resonant capacitor in combination with the sampling unit. The resonant cavity current sampling unit also samples the current information of the resonant cavity in one complete switching cycle. Since the resonant cavity current sampling unit does not need to be connected in series in a loop, compared with CS sampling, this type of sampling is lossless sampling without efficiency loss, and the CS resistor is lossy sampling.

The primary controller unit 1005 is further configured to perform overcurrent protection on the resonant cavity according to the current information of the resonant cavity in a case that the first switching tube Q₁ is conducted, or the current information of the resonant cavity in a case that the first switching tube Q₁ is turned off and the second switching tube Q₂ is conducted. Specifically, the specific implementation of how to perform overcurrent protection according to the sampled current information may refer to the description in the related art.

As an example, the specific structures of the primary first sampling unit 1004, the primary second sampling unit 1003, and the secondary sampling unit may also refer to the description in the related art, which is not limited in the embodiments of the present disclosure.

As an example, as shown in FIG. 5 to FIG. 9, the primary sampling unit may further include the primary first sampling unit 1004. The primary first sampling unit 1004 is connected to the connection node between the first resistor R₁ and the second resistor R₂.

As shown in the structures of FIG. 5 to FIG. 9, the AHB further includes the primary second drive unit 1002, so that the primary controller unit 1005 may control the primary second drive unit 1002 to turn off the second switching tube Q₂ according to the first turn-off signal after receiving the first turn-off signal. Specifically, the primary second drive unit 1002 generates the drive signal for driving the second switching tube Q₂ to turn off based on the control of the primary controller unit 1005, and then transmits the drive signal for driving the second switching tube Q₂ to turn off to the third end of the second switching tube Q₂, so as to drive the second switching tube Q₂ to turn off.

Since the AHB is in different operating modes, the secondary controller unit 1007 determines the turn-off time of the second switching tube Q₂ differently. Therefore, how to determine the turn-off time of the second switching tube Q₂ in different modes will be described below respectively.

In one possible implementation, the AHB operates in a CrM, the secondary controller unit 1007 is configured to use the current zero-crossing time of the synchronous rectifier tube Q₃ as a pre-turn-off time of the second switching tube Q₂, and delay the pre-turn-off time by a first duration as the turn-off time of the second switching tube Q₂. The first duration is adjusted according to whether ZVS of the first switching tube Q₁ is achieved in each switching cycle.

For example, the current zero-crossing time of the synchronous rectifier tube Q₃ is t, and the turn-off time of the second switching tube Q₂ is t+L, where L represents the first duration.

As an example, the secondary controller unit 1007 is configured to trigger a timer or a delay unit to start timing in a case that a time at which the secondary first sampling unit 1008 samples the voltage of the synchronous rectifier tube Q₃ to be zero is used as the current zero-crossing time of the synchronous rectifier tube Q₃, so as to send the first turn-off signal to the primary controller unit 1005 through the isolated communication unit 1006 in a case that a timing value reaches the first duration.

As an example, the first duration may be determined in the following manner.

In one possible implementation of the present disclosure, the secondary controller unit 1007 is configured to maintain the first duration unchanged in a case that the ZVS of the first switching tube Q₁ is achieved in the previous switching cycle, and increase the first duration in a case that the ZVS of the first switching tube is not achieved in the previous switching cycle.

It is understandable that the first duration may be a duration that can satisfy the ZVS of the first switching tube Q₁. For example, the first duration may be a preset duration. If the ZVS of the first switching tube Q₁ is achieved in the previous switching cycle, the second switching tube Q₂ is turned off after a delay of the preset duration following time t. If the ZVS of the first switching tube Q₁ is not achieved in the previous switching cycle, the second switching tube Q₂ is turned off after a delay of the second duration following time t. The second duration is greater than the first duration. For example, the second duration is obtained by adding a certain time difference to the first duration. The time difference may be a preset value or may be determined by the secondary controller unit 1007, which is not limited in the embodiments of the present disclosure.

In one possible embodiment of the present disclosure, as shown in FIG. 5 to FIG. 9, the half-bridge control circuit may further include the secondary first sampling unit 1008. One end of the secondary first sampling unit 1008 is connected to the first end (i.e., the drain) of the synchronous rectifier tube Q₃, and the other end is connected to the secondary controller unit 1007. The secondary first sampling unit 1008 is configured to collect a voltage at the first end of the synchronous rectifier tube Q₃ before the first switching tube Q₁ is turned on and in a case that the first switching tube Q₁ is turned on. The secondary controller unit 1007 is configured to: in a case that the first switching tube Q₁ is about to turn on, on the condition that the voltage at the first end of the synchronous rectifier tube is lower than the voltage at the first end of the synchronous rectifier tube Q₃ in a case that the first switching tube Q₁ is turned on in the previous switching cycle, increase the first duration until, in a case that the first switching tube Q₁ is turned on, the voltage at the first end of the synchronous rectifier tube Q₃ is equal to the voltage at the first end of the synchronous rectifier tube Q₃ in a case that the first switching tube Q₁ is turned on, and the first duration is no longer increased.

As an example, in a case that the first switching tube Q₁ is turned on, the voltage at the first end of the synchronous rectifier tube Q₃ is equal to the voltage at the first end of the synchronous rectifier tube Q₃ in a case that the first switching tube Q₁ is turned on, which may be understood as: in a case that the first switching tube Q₁ is turned on, the voltage at the first end of the synchronous rectifier tube Q₃ is completely equal to the voltage at the first end of the synchronous rectifier tube Q₃ in a case that the first switching tube Q₁ is turned on, or in a case that the first switching tube Q₁ is turned on, a difference between the voltage at the first end of the synchronous rectifier tube Q₃ and the voltage at the first end of the synchronous rectifier tube Q₃ in a case that the first switching tube Q₁ is turned on is within a certain range.

As an example, the secondary controller unit 1007 may increase the first duration according to a certain preset value.

In one possible embodiment of the present disclosure, as shown in FIG. 5 to FIG. 9, the half-bridge control circuit may further include the primary first sampling unit 1004. The secondary controller unit 1007 is configured to: in a case that the first switching tube Q₁ is about to turn on, on the condition that the voltage collected by the primary first sampling unit 1004 is lower than the voltage collected by the primary first sampling unit 1004 in a case that the first switching tube Q₁ is turned on in the previous switching cycle, increase the first duration until, in a case that the first switching tube Q₁ is turned on, the voltage collected by the primary first sampling unit 1004 is equal to the voltage collected by the primary first sampling unit 1004 in a case that the first switching tube Q₁ is turned on, and the first duration is no longer increased.

In one possible embodiment of the present disclosure, in a case that the AHB operates in the CrM, in order to achieve the ZVS of the first switching tube Q₁, the primary controller unit 1005 is further configured to drive the first switching tube Q₁ to conduct after a first dead-time interval T_{dead2} has elapsed from the time when the second switching tube Q₂ is turned off.

As an example, the first dead-time interval T_{dead2} may be transmitted from the secondary controller unit 1007 to the primary controller unit 1005 through the isolated communication unit 1006. For example, in a case that sending the first turn-off signal to the primary controller unit 1005 through the isolated communication unit 1006, the secondary controller unit 1007 also sends the first dead-time interval T_{dead2} to the primary controller unit 1005 to trigger the primary controller unit 1005 to control the first switching tube Q₁ to turn on after the first dead-time interval T_{dead2} has elapsed from the time when the second switching tube Q₂ is turned off, so as to achieve the ZVS of the first switching tube Q₁. Or, the first dead-time interval T_{dead2} is set in the primary controller unit 1005, and the primary controller unit 1005 is configured by default to: in the CrM, control the first switching tube Q₁ to conduct after the first dead-time interval T_{dead2} has elapsed from the time when the second switching tube Q₂ is turned off.

In one possible implementation of the present disclosure, the primary controller unit 1005 is configured to: after controlling the second switching tube Q₂ to turn off, trigger the timer or delay unit to start timing, so that in a case that the timing value reaches T_{dead2}, the primary controller unit 1005 controls the primary first drive unit 1001 to generate the drive signal for controlling the first switching tube Q₁ to conduct.

In another possible implementation of the present disclosure, the secondary controller unit 1007 may delay the first dead-time interval T_{dead2} from the time when the second switching tube Q₂ is turned off, and then send a conducting signal for turning on the first switching tube Q₁ to the primary controller unit 1005 through the isolated communication unit 1006. In this way, the primary controller unit 1005 may control the primary first drive unit 1001 to generate the drive signal for controlling the first switching tube Q₁ to conduct after receiving the conducting signal.

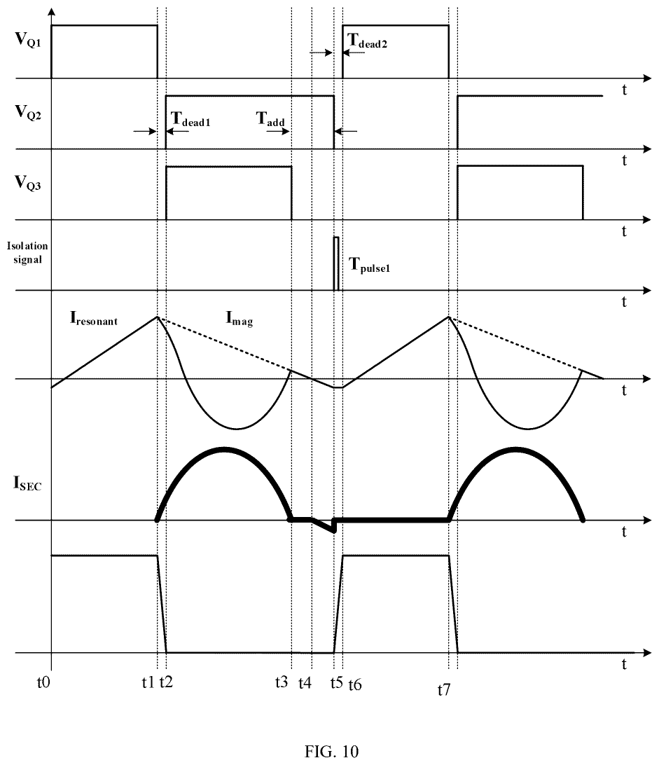

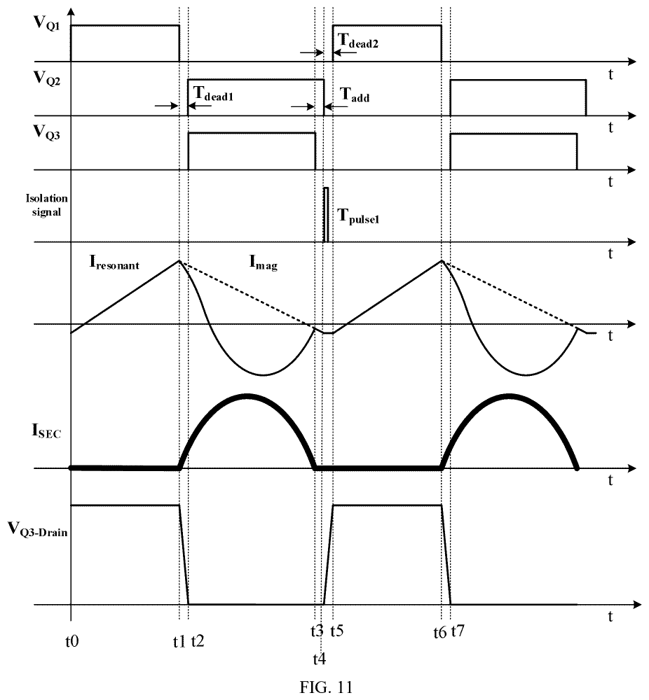

In combination with FIG. 5 to FIG. 9, referring to the operating waveforms of the AHB in the CrM shown in FIG. 10 and FIG. 11, the operating principle of the AHB in one switching cycle is as follows.

At time t0, the primary controller unit 1005 controls the primary first drive unit 1001 to drive the first switching tube Q₁ to conduct for a certain duration. Specifically, during the time period from t0 to t1, the primary first drive unit 1001 provides the drive signal VQ₁ (e.g., the high-level signal) for the third end of the first switching tube Q₁ to trigger the first switching tube Q₁ to conduct for a certain duration.

During the time period from t0 to t1, the first switching tube Q₁ is conducted, the currents of the resonant inductor Lᵣ and the excitation inductor Lₘ increase, and the resonant capacitor Cᵣ stores energy.

At time t1, the drive signal VQ₁ becomes the low-level signal, and the first switching tube Q₁ is turned off. After the dead-time interval T_{dead1} has elapsed from the time when the first switching tube Q₁ is turned off, i.e., at time t2, the primary controller unit 1005 controls the primary second drive unit 1002 to provide the drive signal VQ₂ (e.g., the high-level signal) for the third end of the second switching tube Q₂ to trigger the second switching tube Q₂ to conduct. In a case that the second switching tube Q₂ is turned on, the resonant inductor Lᵣ resonates with the resonant capacitor Cᵣ, and the energy stored in the resonant capacitor Cᵣ is transmitted from the primary of the transformer T to the secondary. At this time, the synchronous rectifier tube Q₃ is turned on, the current of the excitation inductor of the transformer T decreases linearly, and the excitation inductor Lₘ transmits energy to the secondary.

It is understandable that in order to prevent the first switching tube Q₁ and the second switching tube Q₂ from being conducted at the same time, a certain dead-time interval (such as T_{dead1} and T_{dead2}) is reserved in the drive voltage signals of the first switching tube Q₁ and the second switching tube Q₂.

It is understandable that in a case that the primary controller unit 1005 drives the second switching tube Q₂ to conduct by using the primary second drive unit 1002, the secondary controller unit 1007 drives the synchronous rectifier tube Q₃ to conduct by using the secondary first drive unit 1009.

At time t3, after the secondary controller unit 1007 detects that the current of the synchronous rectifier tube Q₃ crosses zero, the secondary controller unit 1007 uses the current zero-crossing time of the synchronous rectifier tube Q₃ as the pre-turn-off time of the second switching tube Q₂. At the current zero-crossing time of the synchronous rectifier tube Q₃, the primary controller unit 1005 controls the second switching tube Q₂ to continue to turn on for T_{add}, that is, the turn-on time of the second switching tube Q₂ is extended to time t5, and the current of the excitation inductor of the transformer T crosses zero and becomes negative.

At time t5, the secondary controller unit 1007 sends the turn-off signal Tₚᵤₗₛₑ₁ of the second switching tube Q₂ to the primary controller unit 1005 through the isolated communication unit 1006. After receiving the turn-off signal Tₚᵤₗₛₑ₁ of the second switching tube Q₂, the primary controller unit 1005 drives the second switching tube Q₂ to turn off by using the primary second drive unit 1002, and drives the first switching tube Q₁ to turn on by using the primary first drive unit 1001 after the first dead-time interval T_{dead2} has elapsed, i.e., at time t6, so as to achieve the ZVS of the switching tube Q₁.

In one possible implementation of the present disclosure, the first dead-time interval T_{dead2} is set in the primary controller unit 1005, or is obtained by the primary controller unit 1005 through adaptive detection, which is not limited in the embodiments of the present disclosure.

It is understandable that, since the conducting time of the second switching tube Q₂ is extended, the excitation current iLₘ continues to increase linearly in a negative direction after dropping to zero at time t3. During the time period from t4 to t5, the negative excitation current discharges the junction capacitor C₁ of the first switching tube Q₁, so that the ZVS of the first switching tube Q₁ can be achieved at time t6.

It is understandable that the drive signal that triggers the switching tube to conduct may be the high-level signal, and the drive signal that triggers the switching tube to turn off may be the low-level signal.

In one possible embodiment of the present disclosure, the AHB operates in a DCM, and the secondary controller unit 1007 is configured to use the current zero-crossing time of the synchronous rectifier tube Q₃ as the turn-off time of the second switching tube Q₂. That is, in a case that the AHB operates in the DCM, the secondary controller unit 1007 is configured to detect the current zero-crossing time of the synchronous rectifier tube Q₃, and then send the turn-off signal Tₚᵤₗₛₑ₁ of the second switching tube Q₂ to the primary controller unit 1005 through the isolated communication unit 1006 at the current zero-crossing time of the synchronous rectifier tube Q₃. Correspondingly, the primary controller unit 1005 is configured to drive the second switching tube Q₂ to turn off through the primary second drive unit 1002 in response to the turn-off signal Tₚᵤₗₛₑ₁ of the second switching tube Q₂.

As described above, the AHB further includes the secondary first drive unit 1009 connected to the third end of the synchronous rectifier tube Q₃. In one possible embodiment of the present disclosure, in a case that the AHB operates in the DCM, the ZVS of the first switching tube Q₁ may also be achieved in the following manner.

The secondary controller unit 1007 is further configured to drive the synchronous rectifier tube Q₃ to turn on for a second duration through the secondary first drive unit 1009 before the first switching tube Q₁ is turned on in the next switching cycle. The secondary controller unit 1007 sends a first turn-on signal to the primary controller unit 1005 through the isolated communication unit 1006 after the synchronous rectifier tube Q₃ is turned on for the second duration. The first turn-on signal is configured to trigger the first switching tube Q₁ to conduct. The primary controller unit 1005 is further configured to control the first switching tube Q₁ to conduct after a second dead-time interval has elapsed in response to the first turn-on signal.

As an example, the primary controller unit 1005 is further specifically configured to drive the first switching tube Q₁ to conduct after the second dead-time interval has elapsed in response to the first turn-on signal. Then the primary first drive unit 1001 provides the high-level signal for the first switching tube Q₁.

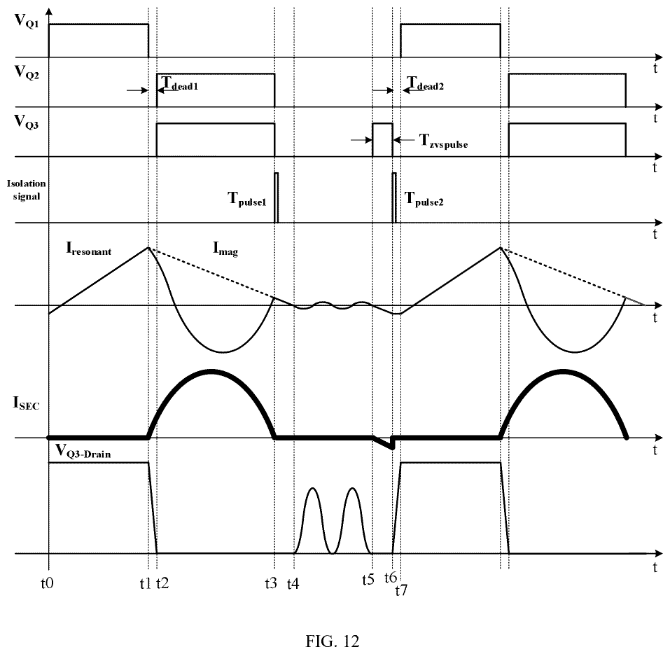

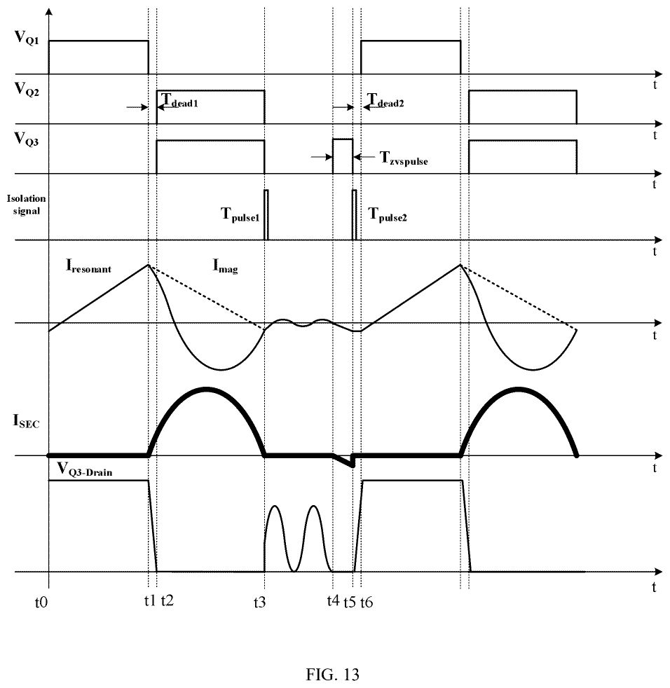

Specifically, in the DCM as shown in FIG. 12 and FIG. 13, at time to, the primary controller unit 1005 controls the primary first drive unit 1001 to provide the high-level drive signal VQ₁ for the first switching tube Q₁ to drive the first switching tube Q₁ to turn on. In a case that the first switching tube Q₁ is turned on, as shown in FIG. 12 and FIG. 13, a resonant cavity current Iᵣₑₛₒₙₐₙₜ (i.e., an excitation current I_{mag}) increases. At time t1, the primary first drive unit 1001 provides the low-level drive signal VQ₁ for the first switching tube Q₁ to turn off the first switching tube Q₁. After a certain dead-time interval T_{dead1} has elapsed from the time when the first switching tube Q₁ is turned off, the primary controller unit 1005 controls the primary second drive unit 1002 to provide the high-level drive signal VQ₂ for the second switching tube Q₂ to drive the second switching tube Q₂ to turn on. At the same time, at time t1, the secondary controller unit 1007 drives the synchronous rectifier tube Q₃ to turn on by using the secondary first drive unit 1009. In a case that the second switching tube Q₂ is turned on (i.e., the time period from t2 to t3), the excitation current I_{mag} of the transformer decreases, and at time t3, the current of the synchronous rectifier tube Q₃ crosses zero. At this time, the current zero-crossing time of the synchronous rectifier tube Q₃ may be used as the turn-off time of the second switching tube Q₂, that is, time t3 is the turn-off time of the second switching tube Q₂, and the secondary controller unit 1007 sends the turn-off signal Tₚᵤₗₛₑ₁ of the second switching tube Q₂ to the primary controller unit 1005 through the isolated communication unit 1006. After receiving the turn-off signal Tₚᵤₗₛₑ₁ of the second switching tube Q₂, the primary controller unit 1005 drives the second switching tube Q₂ to turn off by using the primary second drive unit 1002. At time t3, after the second switching tube Q₂ is turned off, the capacitor Cᵣ demagnetizes the excitation inductor Lₘ of the transformer T. After the current of the excitation inductor crosses zero, the system enters a free resonance state. Before the first switching tube Q₁ is turned on again (i.e., before time t6), the secondary controller unit 1007 sends the turn-on signal of the synchronous rectifier tube Q₃ to the secondary first drive unit 1009 to trigger the synchronous rectifier tube Q₃ to turn on. At this time, the excitation current I_{mag} of the transformer T becomes negative and discharges the junction capacitor C₁ of the first switching tube Q₁. The turn-on duration T_{ZVSpulse} of the synchronous rectifier tube Q₃ is controlled by the secondary controller unit 1007. After T_{ZVSpulse} ends, i.e., at time t5, the secondary controller unit 1007 sends the pulse signal Tₚᵤₗₛₑ₂ for triggering the first switching tube Q₁ to turn on to the primary controller unit 1005 through the isolated communication unit 1006. After receiving the pulse signal Tₚᵤₗₛₑ₂, the primary controller unit 1005 controls the first switching tube Q₁ to conduct at time t6. At this time, the ZVS of the first switching tube Q₁ is achieved.

The difference between FIG. 12 and FIG. 13 is that the position of the excitation current I_{mag} is different.

In the above solution, in the DCM, the secondary synchronous rectifier tube Q₃ is adopted to reversely excite the excitation inductor to ensure that a sufficiently large negative current appears in the excitation inductor of the transformer, thereby achieving the ZVS of the first switching tube Q₁ and reducing the switching loss of the AHB.

In another one possible embodiment of the present disclosure, in a case that the AHB operates in the DCM, the ZVS of the first switching tube Q₁ may also be achieved in the following manner.

Before the first switching tube Q₁ is turned on again in the next switching cycle, the secondary controller unit 1007 is configured to send a second turn-on signal to the primary controller unit 1005 through the isolated communication unit 1006, and the second turn-on signal is configured to trigger the primary controller unit 1005 to control the second switching tube Q₂ to conduct for the second duration.

Optionally, the primary controller unit 1005 is further configured to control the second switching tube Q₂ to conduct for the second duration in response to the second turn-on signal.

Specifically, the primary controller unit 1005 is configured to control, before the first switching tube Q₁ is turned on again in the next switching cycle, the second switching tube Q₂ to conduct for the second duration in response to the second turn-on signal.

As an example, the second turn-on signal may include a turn-on time and a turn-on duration of the second switching tube Q₂, i.e., the second duration, so that the primary controller unit 1005 controls the second switching tube Q₂ to turn on at the turn-on time of the second switching tube Q₂, and controls the second switching tube Q₂ to turn off in a case that the turn-on duration of the second switching tube Q₂ reaches the second duration.

Optionally, the primary controller unit 1005 is further configured to control the second switching tube Q₂ to turn off after the second switching tube Q₂ is turned on for the second duration, and control the first switching tube Q₁ to conduct after the second dead-time interval has elapsed from the time when the second switching tube Q₂ is turned off.

Optionally, in a case that the secondary controller unit 1007 sends the second turn-on signal to the primary controller unit 1005 through the isolated communication unit 1006, the secondary controller unit 1007 is further configured to send the conducting time and the turn-on duration (i.e., the second duration) of the second switching tube Q₂ to the primary controller unit 1005 through the isolated communication unit 1006, which facilitates the primary controller unit 1005 to control the second switching tube Q₂ to conduct at the conducting time of the second switching tube Q₂, and to control the second switching tube Q₂ to turn off after the second switching tube Q₂ is conducted for the second duration.

The above second dead-time interval may be sent by the secondary controller unit 1007 to the primary controller unit 1005 through the isolated communication unit 1006, or may be set in the primary controller unit 1005, which is not limited in the embodiments of the present disclosure.

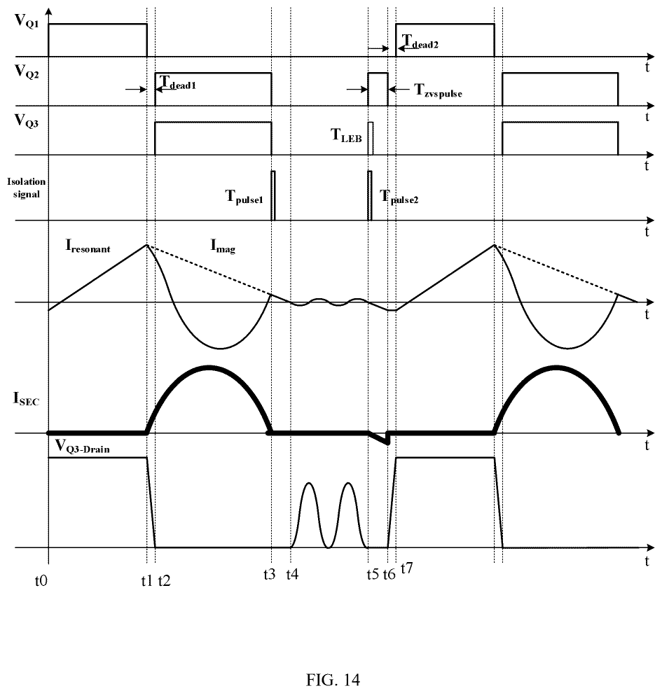

For example, in the DCM as shown in FIG. 14, at time t0, the first switching tube Q₁ is turned on. In a case that the first switching tube Q₁ is turned on (from time t0 to time t1), the excitation current of the transformer T increases, the currents of the resonant inductor Lᵣ and the excitation inductor Lₘ increase, and the resonant capacitor Cᵣ stores energy.

At time t1, the first switching tube Q₁ is turned off, and after the dead-time interval T_{dead1} has elapsed, the primary controller unit 1005 drives the second switching tube Q₂ to turn on at time t2 by using the primary second drive unit 1002.

In a case that the second switching tube Q₂ is turned on, the resonant inductor Lᵣ resonates with the resonant capacitor Cᵣ, and the excitation current of the transformer T decreases. At time t3, after the current of the synchronous rectifier tube Q₃ crosses zero, which is the turn-off time of the second switching tube Q₂, the secondary controller unit 1007 sends the pulse signal Tₚᵤₗₛₑ₁ for triggering the second switching tube Q₂ to turn off to the primary controller unit 1005 through the isolated communication unit 1006. The primary controller unit 1005 receives the pulse signal Tₚᵤₗₛₑ₁, and at time t3, controls the primary second drive unit 1002 to drive the second switching tube Q₂ to turn off. After the second switching tube Q₂ is turned off, the resonant capacitor Cᵣ demagnetizes the excitation inductor of the transformer T. After the current of the excitation inductor crosses zero, the system enters a free resonance state. Before the first switching tube Q₁ in the next switching cycle is turned on again, i.e., at time t7, the secondary controller unit 1007 sends the pulse signal Tₚᵤₗₛₑ₂ to the primary controller unit 1005 through the isolated communication unit 1006. The pulse signal Tₚᵤₗₛₑ₂ is configured to trigger the primary controller unit 1005 to control the second switching tube Q₂ to turn on for the second duration (i.e., T_{ZVSpulse} duration). The primary controller unit 1005 controls the primary second drive unit 1002 to drive the second switching tube Q₂ to turn on for the T_{ZVSpulse} duration based on the pulse signal Tₚᵤₗₛₑ₂ at time t5. In a case that the second switching tube Q₂ is turned on (from time t5 to time t6), the excitation current of the transformer T becomes negative. At the time of Tₚᵤₗₛₑ₂ (i.e., time t5), the synchronous rectifier tube Q₃ may blank for a T_{LEB} time. During the T_{LEB} time, the secondary controller unit 1007 does not detect the whether the synchronous rectifier tube Q₃ is turned on. The turn-on duration T_{ZVSpulse} of the second switching tube Q₂ is controlled by the secondary controller unit 1005.

After the primary controller unit 1005 detects that the turn-on duration of the second switching tube Q₂ reaches T_{ZVSpulse}, that is, after T_{ZVSpulse} ends, the primary controller unit 1005 controls the first switching tube Q₁ to turn on after a certain dead-time interval T_{dead2} has elapsed. At this time, the ZVS of the first switching tube Q₁ is achieved.

In the above solution, in the DCM, the second switching tube Q₂ is adopted to reversely excite the excitation inductor to ensure that a sufficiently large negative current appears in the excitation inductor of the transformer, thereby achieving the ZVS of the first switching tube Q₁ and reducing the switching loss of the AHB.

The above solution discloses that in the DCM, before the first switching tube Q₁ is turned on, the ZVS of the first switching tube Q₁ is achieved by using the synchronous rectifier tube Q₃ or the second switching tube Q₂. A control method for the T_{ZVSpulse} turn-on duration of the synchronous rectifier tube Q₃ or the second switching tube Q₂ will be described below.

In one possible implementation of the present disclosure, T_{ZVSpulse} is calculated by an input voltage sampled by the secondary controller unit 1007 through the secondary first sampling unit 1008 and output voltage information. For example, T_{ZVSpulse}=k*Vᵢₙ/Vₒᵤₜ, where the coefficient k is determined by external divider resistors R₁ and R₂ and internal setting parameters of the half-bridge control circuit 100, Vᵢₙ represents the input voltage of the AHB, and Vₒᵤₜ represents the output voltage of the AHB.

In another possible implementation of the present disclosure, the T_{ZVSpulse} turn-on duration is adjusted in real time according to whether the ZVS of the first switching tube Q₁ is achieved in each switching cycle. In a case that the first switching tube Q₁ is turned on, on the condition that the voltage sampled by the secondary controller unit 1007 through the secondary first sampling unit 1008 is lower than a platform voltage sampled by the secondary controller unit 1007 through the secondary first sampling unit in a case that the first switching tube Q₁ is turned on in the previous switching cycle, the T_{ZVSpulse} turn-on duration increases until, in a case that the first switching tube Q₁ is turned on, the voltage sampled by the secondary controller unit 1007 through the secondary first sampling unit 1008 is equal to the platform voltage sampled by the secondary controller unit 1007 through the secondary first sampling unit 1008 in a case that the switching tube Q₁ is turned on in the previous switching cycle, and the T_{ZVSpulse} turn-on duration is no longer increased.

In another possible embodiment of the present disclosure, the output end of the AHB is connected to a load, and the load receives electric energy (e.g., voltage and current) converted by the AHB.

In some examples, the electric energy converted by the AHB also passes through a filter before reaching the load. In some examples, the filter is a subcomponent of the AHB, an external component of the AHB, and/or a subcomponent of the load. In any case, the load may perform functions by using filtered or unfiltered electric energy from the AHB. Optionally, the load may include, but is not limited to, a computing device and related components, such as a microprocessor, an electrical component, a circuit, a laptop computer, a desktop computer, a tablet computer, a mobile phone, a battery, a speaker, a lighting unit, an automobile/ship/aircraft/train related component, a motor, a transformer, or any other type of electrical device and/or circuit that receives voltage or current from the flyback converter.

In some examples, in the CrM, after the current of the synchronous rectifier tube Q₃ crosses zero, the secondary controller unit 1007 controls the synchronous rectifier tube Q₃ to turn off, and the primary controller unit 1005 continues to control the second switching tube Q₂ to conduct for the T_{add} time. After the second switching tube Q₂ is conducted for the T_{add} time, the primary controller unit 1005 controls the second switching tube Q₂ to turn off, and then after the interval T_{dead2} has elapsed, the first switching tube Q₁ is turned on again. In the DCM, the synchronous rectifier tube Q₃ actively turns on to reversely excite the transformer. After T_{ZVSpulse} ends, the synchronous rectifier tube Q₃ is turned off, and the secondary controller unit 1007 transmits the turn-on signal Tₚᵤₗₛₑ₂ of the first switching tube Q₁ to the primary controller unit 1005 through the isolated communication unit 1006. After the interval T_{dead2} has elapsed, the first switching tube Q₁ is turned on again. In this way, the problem that the first switching tube Q₁ and the synchronous rectifier tube Q₃ are turned on at the same time may be solved.

As an example, the primary controller unit 1005, the primary first drive unit 1001, the primary second drive unit 1002, the primary second sampling unit 1003, and the primary first sampling unit 1004 may be integrated together as a primary controller or a primary control chip. The primary controller or the primary control chip has the functions of the primary controller unit 1005, the primary first drive unit 1001, the primary second drive unit 1002, the primary second sampling unit 1003, and the primary first sampling unit 1004.

As another example, the secondary first sampling unit 1008, the secondary first drive unit 1009, and the secondary controller unit 1007 may be integrated together as a secondary controller or a secondary control chip.

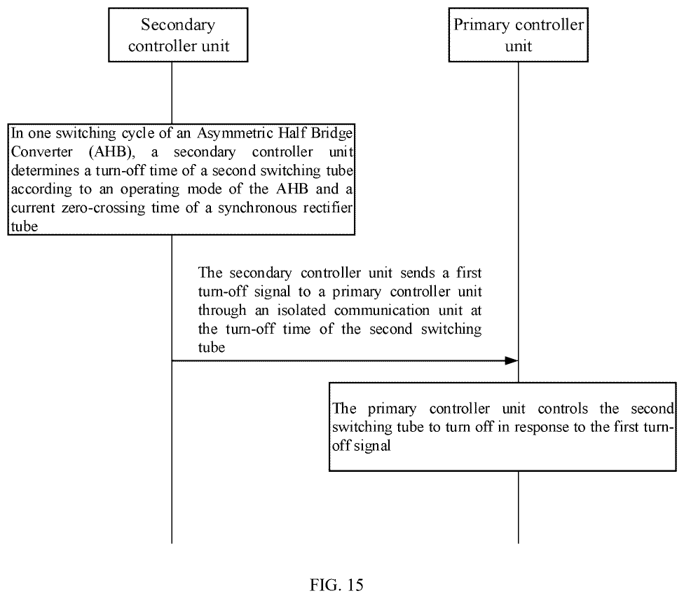

As shown in FIG. 15, FIG. 15 is a control method for an AHB according to an embodiment of the present disclosure. The AHB includes a half-bridge circuit, a transformer, and a half-bridge control circuit. The half-bridge circuit includes a first switching tube and a second switching tube connected in series between an input capacitor and a first reference ground. The half-bridge control circuit includes a primary controller unit and a secondary controller unit. The primary controller unit communicates with the secondary controller unit through an isolated communication unit, the primary controller unit is configured to drive the first switching tube and the second switching tube, and the secondary controller unit is configured to drive a synchronous rectifier tube connected in series with a secondary winding of the transformer. In one switching cycle of the AHB, the secondary controller unit determines a turn-off time of the second switching tube according to an operating mode of the AHB and a current zero-crossing time of the synchronous rectifier tube. The secondary controller unit sends a first turn-off signal to the primary controller unit through the isolated communication unit at the turn-off time of the second switching tube. The first turn-off signal is configured to trigger the primary controller unit to turn off the second switching tube. The primary controller unit controls the second switching tube to turn off in response to the first turn-off signal.

In one possible implementation of the present disclosure, the method provided by the embodiments of the present disclosure further includes that: in a case that the AHB operates in a CrM, the primary controller unit drives the first switching tube to conduct after a first dead-time interval has elapsed from the time when the second switching tube is turned off.

In one possible implementation of the present disclosure, the method provided by the embodiments of the present disclosure further includes that: the primary controller unit further receives the first turn-off signal from the secondary controller unit through the isolated communication unit, and further receives the first dead-time interval.

In one possible implementation of the present disclosure, the operation that in one switching cycle of the AHB, the secondary controller unit determines the turn-off time of the second switching tube according to the operating mode of the AHB and the current zero-crossing time of the synchronous rectifier tube includes that: the AHB operates in the CrM, and the secondary controller unit uses the current zero-crossing time of the synchronous rectifier tube as a pre-turn-off time of the second switching tube, and delays the pre-turn-off time by a first duration as the turn-off time of the second switching tube. The first duration is adjusted according to whether ZVS of the first switching tube is achieved in each switching cycle.

In one possible implementation of the present disclosure, the operation that in one switching cycle of the AHB, the secondary controller unit determines the turn-off time of the second switching tube according to the operating mode of the AHB and the current zero-crossing time of the synchronous rectifier tube includes that: the AHB operates in a DCM, and the secondary controller unit uses the current zero-crossing time of the synchronous rectifier tube as the turn-off time of the second switching tube.

In one possible implementation of the present disclosure, the half-bridge control circuit further includes a secondary first sampling unit connected to the secondary controller unit. The secondary first sampling unit is configured to collect a voltage at a first end of the synchronous rectifier tube before and in a case that the first switching tube is turned on. The secondary controller unit is configured to: before the first switching tube is turned on, on the condition that the voltage at the first end of the synchronous rectifier tube is lower than the voltage at the first end of the synchronous rectifier tube in a case that the first switching tube is turned on in the previous switching cycle, increase the first duration until, in a case that the first switching tube is turned on, the voltage at the first end of the synchronous rectifier tube is equal to the voltage at the first end of the synchronous rectifier tube in a case that the first switching tube is turned on, and the first duration is no longer increased.

In one possible implementation of the present disclosure, the half-bridge control circuit further includes a secondary first drive unit connected to a third end of the synchronous rectifier tube, the secondary first drive unit being further connected to the secondary controller unit. The secondary controller unit further drives the synchronous rectifier tube to turn on for a second duration through the secondary first drive unit before the first switching tube is turned on in the next switching cycle, and sends a first turn-on signal and a second dead-time interval to the primary controller unit through the isolated communication unit after the synchronous rectifier tube is turned on for the second duration. The first turn-on signal is configured to trigger the first switching tube to conduct, and the primary controller unit controls the first switching tube to conduct after the second dead-time interval has elapsed in response to the first turn-on signal.

In one possible implementation of the present disclosure, after the second switching tube is turned off, the method provided by the embodiments of the present disclosure may further include that: the secondary controller unit sends a second turn-on signal to the primary controller unit through the isolated communication unit before the first switching tube is turned on again in the next switching cycle, where the second turn-on signal is configured to trigger the primary controller unit to control the second switching tube to conduct for the second duration; and the primary controller unit controls the second switching tube to conduct for the second duration in response to the second turn-on signal, and controls the first switching tube to conduct after the second switching tube is conducted for the second duration and the second dead-time interval has elapsed.

In one possible implementation of the present disclosure, the second duration is calculated by an input voltage sampled by the secondary controller unit through the secondary first sampling unit and output voltage information of the transformer.

In one possible implementation of the present disclosure, the half-bridge control circuit further includes the secondary first sampling unit connected to the secondary controller unit. The secondary first sampling unit is configured to collect the voltage at the first end of the synchronous rectifier tube before and in a case that the first switching tube is turned on. The method provided by the embodiments of the present disclosure may further include that: the secondary controller unit is configured to: in a case that the first switching tube is about to turn on, on the condition that the voltage at the first end of the synchronous rectifier tube is lower than the voltage at the first end of the synchronous rectifier tube in a case that the first switching tube is turned on in the previous switching cycle, increase the second duration until, in a case that the first switching tube is turned on, the voltage at the first end of the synchronous rectifier tube is equal to the voltage at the first end of the synchronous rectifier tube in a case that the first switching tube is turned on, and the second duration is no longer increased.

Finally, it is to be noted that the above is only the specific implementation of the present disclosure and not intended to limit the scope of protection of the present disclosure. Any variations or replacements within the technical scope disclosed by the present disclosure shall fall within the scope of protection of the present disclosure. Therefore, the scope of protection of the present disclosure shall be subjected to the scope of protection of the claims.

1. A half-bridge control circuit for driving a half-bridge circuit in an Asymmetric Half Bridge Converter (AHB) and a synchronous rectifier tube connected in series with a secondary winding of a transformer in the AHB, wherein the half-bridge circuit comprises a first switching tube and a second switching tube, wherein the first switching tube and the second switching tube are connected in series between an input capacitor and a first reference ground, a first end of the first switching tube is connected to a first end of the input capacitor, a second end of the input capacitor is connected to the first reference ground, a second end of the first switching tube is connected to a first end of the second switching tube, and a second end of the second switching tube is connected to the first reference ground;
the half-bridge control circuit comprises a primary controller unit, an isolated communication unit, and a secondary controller unit, wherein the primary controller unit communicates with the secondary controller unit through the isolated communication unit, the primary controller unit is configured to drive the first switching tube and the second switching tube to conduct in different time periods, and the secondary controller unit is configured to drive the synchronous rectifier tube to conduct or turn off;
in one switching cycle of the AHB, the secondary controller unit is configured to determine a turn-off time of the second switching tube according to an operating mode of the AHB and a current zero-crossing time of the synchronous rectifier tube, and send a first turn-off signal to the primary controller unit through the isolated communication unit at the turn-off time, wherein the first turn-off signal is configured to trigger the primary controller unit to turn off the second switching tube; and
the primary controller unit is configured to control the second switching tube to turn off in response to the first turn-off signal.

2. The half-bridge control circuit according to claim 1, wherein the AHB operates in a Critical Mode (CrM), and the secondary controller unit is configured to use the current zero-crossing time of the synchronous rectifier tube as a pre-turn-off time of the second switching tube, and delay the pre-turn-off time by a first duration as the turn-off time of the second switching tube, wherein the first duration is adjusted according to whether Zero Voltage Switching (ZVS) of the first switching tube is achieved in each switching cycle; and
the AHB operates in a Discontinuous Conduction Mode (DCM), and the secondary controller unit is configured to use the current zero-crossing time of the synchronous rectifier tube as the turn-off time of the second switching tube.

3. The half-bridge control circuit according to claim 2, wherein the secondary controller unit is configured to:
maintain the first duration unchanged in a case that the ZVS of the first switching tube is achieved in a previous switching cycle, and increase the first duration in a case that the ZVS of the first switching tube is not achieved in the previous switching cycle.

4. The half-bridge control circuit according to claim 3, further comprising a secondary first sampling unit connected to the secondary controller unit, wherein the secondary first sampling unit is configured to collect a voltage at a first end of the synchronous rectifier tube before and in a case that the first switching tube is turned on; and
the secondary controller unit is configured to:
before the first switching tube is turned on, on a condition that the voltage at the first end of the synchronous rectifier tube is lower than the voltage at the first end of the synchronous rectifier tube in a case that the first switching tube is turned on in the previous switching cycle, increase the first duration until, in a case that the first switching tube is turned on, the voltage at the first end of the synchronous rectifier tube is equal to the voltage at the first end of the synchronous rectifier tube in a case that the first switching tube is turned on, and the first duration is no longer increased.

5. The half-bridge control circuit according to claim 1, wherein in a case that the AHB operates in the CrM,
the primary controller unit is further configured to control the first switching tube to conduct after a first dead-time interval has elapsed from a time when the second switching tube is turned off.

6. The half-bridge control circuit according to claim 1, further comprising a secondary first drive unit, wherein the secondary first drive unit is connected to a third end of the synchronous rectifier tube and the secondary controller unit;
the secondary controller unit is further configured to drive the synchronous rectifier tube to turn on for a second duration through the secondary first drive unit before the first switching tube is turned on in a next switching cycle, and is configured to send a first turn-on signal to the primary controller unit through the isolated communication unit after the synchronous rectifier tube is turned on for the second duration, wherein the first turn-on signal is configured to trigger the first switching tube to conduct; and
the primary controller unit is further configured to drive the first switching tube to conduct in the next switching cycle after a second dead-time interval has elapsed in response to the first turn-on signal.

7. The half-bridge control circuit according to claim 1, wherein,
the secondary controller unit is further configured to send a second turn-on signal to the primary controller unit through the isolated communication unit before the first switching tube is turned on again in a next switching cycle, wherein the second turn-on signal is configured to trigger the primary controller unit to control the second switching tube to conduct for a second duration; and
the primary controller unit is further configured to control the second switching tube to conduct for the second duration in response to the second turn-on signal, and control the first switching tube to conduct in the next switching cycle after the second switching tube is conducted for the second duration and a second dead-time interval has elapsed.

8. The half-bridge control circuit according to claim 6, wherein the second duration is calculated by an input voltage sampled by the secondary controller unit through a secondary first sampling unit and output voltage information of the transformer.

9. The half-bridge control circuit according to claim 6, further comprising a secondary first sampling unit connected to the secondary controller unit, wherein the secondary first sampling unit is configured to collect a voltage at a first end of the synchronous rectifier tube before and in a case that the first switching tube is turned on; and
the secondary controller unit is configured to:
in a case that the first switching tube is about to turn on, on a condition that the voltage at the first end of the synchronous rectifier tube is lower than the voltage at the first end of the synchronous rectifier tube in a case that the first switching tube is turned on in a previous switching cycle, increase the second duration until, in a case that the first switching tube is turned on, the voltage at the first end of the synchronous rectifier tube is equal to the voltage at the first end of the synchronous rectifier tube in a case that the first switching tube is turned on, and the second duration is no longer increased.

10. The half-bridge control circuit according to claim 1, further comprising a primary sampling unit, wherein the primary sampling unit is connected to the primary controller unit, and is configured to collect current information of a resonant cavity in a case that the first switching tube is turned on, or is configured to collect the current information of the resonant cavity in a case that the first switching tube is turned on and current information of the resonant cavity in a case that the second switching tube is turned on in one switching cycle; and
the primary controller unit is further configured to perform overcurrent protection on the resonant cavity comprising a resonant inductor, a primary winding of the transformer and a resonant capacitor according to the current information of the resonant cavity in a case that the first switching tube is turned on.

11. The half-bridge control circuit according to claim 10, wherein the AHB further comprises a sampling resistor, wherein a second end of the second switching tube is connected to a first end of the sampling resistor, a second end of the sampling resistor is connected to the first reference ground, and the primary sampling unit is connected to the first end of the sampling resistor; and
the primary sampling unit is configured to collect the current information of the resonant cavity in a case that the first switching tube is conducted in one switching cycle.

12. The half-bridge control circuit according to claim 11, wherein the second switching tube is connected in parallel with the resonant cavity; or,
the first switching tube is connected in parallel with the resonant cavity.

13. The half-bridge control circuit according to claim 9, wherein the AHB further comprises a sampling resistor, a resonant inductor, and a resonant capacitor, wherein a second end of the second switching tube and a first end of the sampling resistor are connected to the first reference ground, the second switching tube is connected in parallel with a resonant cavity, wherein the resonant cavity is formed by the resonant inductor, a primary winding of the transformer and the resonant capacitor, the primary sampling unit is coupled to the second end of the second switching tube, and the primary sampling unit is configured to collect current information of the resonant cavity in a case that the first switching tube is conducted and current information of the resonant cavity in a case that the second switching tube is conducted in one switching cycle.

14. The half-bridge control circuit according to claim 9, wherein the AHB further comprises a resonant inductor, a resonant cavity current sampling unit, and a resonant capacitor, wherein a second end of the second switching tube is connected to the first reference ground, the second switching tube is connected in parallel with a resonant cavity, wherein the resonant cavity is formed by the resonant inductor, a primary winding of the transformer and the resonant capacitor, the primary sampling unit is connected to the resonant cavity current sampling unit, and the resonant cavity current sampling unit is connected between the resonant capacitor and the primary winding.

15. The half-bridge control circuit according to claim 1, wherein a third end of the synchronous rectifier tube is connected to the secondary controller unit through a secondary first drive unit, a first end of the synchronous rectifier tube is connected to a non-dot end of the secondary winding of the transformer, a second end of the synchronous rectifier tube is connected to a first end of an output capacitor of the AHB, and a second end of the output capacitor is connected to a dot end of the secondary winding;
or, the second end of the synchronous rectifier tube is connected to the dot end of the secondary winding of the transformer, the first end of the synchronous rectifier tube is connected to the second end of the output capacitor of the AHB, and the first end of the output capacitor is connected to the non-dot end of the secondary winding.

16. An Asymmetric Half Bridge Converter (AHB), comprising:
a transformer, the transformer comprising a primary winding, an auxiliary winding, and a secondary winding;
a synchronous rectifier tube connected in series with the secondary winding;
a half-bridge circuit, comprising a first switching tube and a second switching tube, wherein the first switching tube and the second switching tube are connected in series between an input capacitor and a first reference ground; and
the half-bridge control circuit according to claim 1.

17. A control method for an Asymmetric Half Bridge Converter (AHB), wherein the AHB comprises a half-bridge circuit, a transformer, and a half-bridge control circuit, wherein the half-bridge circuit comprises a first switching tube and a second switching tube, wherein the first switching tube and the second switching tube are connected in series between an input capacitor and a first reference ground;
the half-bridge control circuit comprises a primary controller unit and a secondary controller unit, wherein the primary controller unit communicates with the secondary controller unit through an isolated communication unit, the primary controller unit is configured to control the first switching tube and the second switching tube to conduct in different time periods, and the secondary controller unit is configured to control a synchronous rectifier tube connected in series with a secondary winding of the transformer;
wherein the control method comprises:
in one switching cycle of the AHB, determining, by the secondary controller unit, a turn-off time of the second switching tube according to an operating mode of the AHB and a current zero-crossing time of the synchronous rectifier tube;
sending, by the secondary controller unit, a first turn-off signal to the primary controller unit through the isolated communication unit at the turn-off time of the second switching tube, wherein the first turn-off signal is configured to trigger the primary controller unit to turn off the second switching tube; and
controlling, by the primary controller unit, the second switching tube to turn off in response to the first turn-off signal.

18. The control method according to claim 17, further comprising:
in a case that the AHB operates in a Critical Mode (CrM), controlling, by the primary controller unit, the first switching tube to conduct in a next switching cycle after a first dead-time interval has elapsed from a time when the second switching tube is turned off.
